(19) United States
(12) Patent Application Publication
(10) Pub. No.: US 2006/0121392 A1
(43) Pub. Date: Jun. 8, 2006

(54) Optical filter and display using the same

(75) Inventor: Yuji Nakatsugawa, Tokyo-To (JP)

Correspondence Address: BURR & BROWN, PO BOX 7068, SYRACUSE, NY, 13261-7068, US

(73) Assignee: Dai Nippon Printing Co., Ltd., Shinjuku-Ku (JP)

(21) Appl. No.: 11/284,411

(22) Filed: Nov. 21, 2005

(30) Foreign Application Priority Data
Nov. 24, 2004 (JP) 2004-339056
Feb. 17, 2005 (JP) 2005-40750
Apr. 5, 2005 (JP) 2005-108760

(51) Int. Cl. G11B 7/24

(52) U.S. Cl. 430/270.17

(57) ABSTRACT

An optical filter including at least a coloring matter layer that includes a coloring matter having an absorption maximum wavelength in a wavelength region of 800 to 1100 nm and a coloring matter having an absorption maximum in a wavelength region of 570 to 610 nm contained in an identical layer. The coloring matter layer does not substantially contain two or more ionic coloring matter compounds different from each other in cation part. The optical filter can be disposed on the viewing side of a display. By virtue of the above construction, the optical filter and display, even when a plurality of coloring matters are present as a mixture in an identical coloring matter layer, can realize suppression of interaction between coloring matters and do not cause any change in spectral characteristics even under use for a long period of time.

### BACKGROUND OF THE INVENTION

In recent years, studies on electronic displays such as plasma displays (hereinafter referred to as “PDPs”) have become actively made. Near infrared light with wavelengths 800 nm to 1100 nm emitted from a luminous body in these displays sometimes cause malfunction of peripheral devices utilizing near infrared light, for example, remote controllers of domestic appliances. Accordingly, the installation of near infrared absorbing coloring matter-containing near infrared absorbing filters on the front face of displays is indispensable. In general, in these near infrared absorbing filters, a near infrared absorbing coloring matter is used as a component for absorbing near infrared light with the above wavelengths.

Anthraquinone, naphthoquinone, phthalocyanine, squalirium, diimmonium, dithiol coloring matters and the like are generally used as near infrared absorbing coloring matters (for example, Japanese Patent Laid-Open Nos. 323121/1999 and 158762/2001).

On the other hand, PDPs suffer from a problem that the intensity of light around 590 nm attributable to emission of light from neon gas is so high that red light emission is somewhat orangish. To overcome this problem, in addition to the capability of absorbing light with wavelengths 800 nm to 1100 nm, the function of absorbing light with a wavelength around 590 nm is also required of the front face of the display. The use of cyanine coloring matters, methine coloring matters, or porphyrin coloring matters has been attempted to impart this function (Japanese Patent Laid-Open No. 131435/2001).

The presence of the near infrared absorbing coloring matter together with the absorbing coloring matter having an absorption maximum at a wavelength around 590 nm in an identical layer, however, is disadvantageously likely to cause deactivation of the performance of the coloring matter. The deactivation of the performance is particularly significant when coloring matters having a skeleton comprising cation and anion, such as diimmonium coloring matters and squarylium coloring matters, and cyanine coloring matters and methine coloring matters, are present together in an identical layer.

Japanese Patent Laid-Open No. 123180/2002 describes an invention in which a phthalocyanine near infrared absorbing compound and a coloring matter having absorption in a visible region are used in combination. However, there is no specific description about coloring matters having absorption in a visible region, and, accordingly, the probability that selected coloring matters having absorption in a visible region cause deactivation of the performance is considerably high.

Thus, in the prior art technique, although the development of the function of absorbing light with wavelengths 800 nm to 1100 nm and the function of absorbing light with a wavelength around 590 nm in a single layer is temporarily possible, the continuation of this development for a long period of time is difficult, and, so far as the present inventor knows, any optical filter having durability high enough to satisfy practical use requirements has not been developed.

### SUMMARY OF THE INVENTION

An object of the present invention is to provide an optical filter that comprises a coloring matter layer containing a plurality of coloring matters in an identical layer and has both the function of absorbing near infrared light with wavelengths 800 nm to 1100 nm and the function of absorbing light with a wavelength around 590 nm and has durability high enough to cause no change in spectral characteristics even under use for a long period of time. Another object of the present invention is to provide a display comprising an optical filter provided by attaining the above object.

The present inventors have made extensive and intensive studies with a view to attaining the above objects of the present invention and, as a result, have found that, in a coloring matter layer comprising at least a coloring matter having an absorption maximum wavelength in a wavelength region of 800 nm to 1100 nm and a coloring matter having an absorption maximum wavelength in a wavelength region of 570 nm to 610 nm contained in an identical layer, when two or more ionic coloring matter compounds different from each other in cation part are not used, a highly durable optical filter, which, even when coloring matters are present as a mixture in an identical layer, can suppress interaction between coloring matters and does not cause any change in spectral characteristics even under use for a long period of time, and a display comprising this optical filter can be provided. This has led to the completion of the present invention.

Further, the present inventors have found that a further improved highly durable optical filter and a display comprising this optical filter can be provided by using a specific phthalocyanine coloring matter as a coloring matter having an absorption maximum in a wavelength region of 800 nm to 1100 nm and a specific tetraazaporphyrin coloring matter as a coloring matter having an absorption maximum in a wavelength region of 570 nm to 610 nm.

The first invention provides an optical filter comprising at least a coloring matter layer comprising a coloring matter having an absorption maximum wavelength in a wavelength region of 800 to 1100 nm and a coloring matter having an absorption maximum in a wavelength region of 570 to 610 nm contained in an identical layer, wherein said coloring matter layer does not substantially contain two or more ionic coloring matter compounds different from each other in cation part.

The second invention provides an optical filter in which, in the first invention, said coloring matter having an absorption maximum wavelength in a wavelength region of 800 to 1100 nm is at least a phthalocyanine coloring matter represented by formula (1): 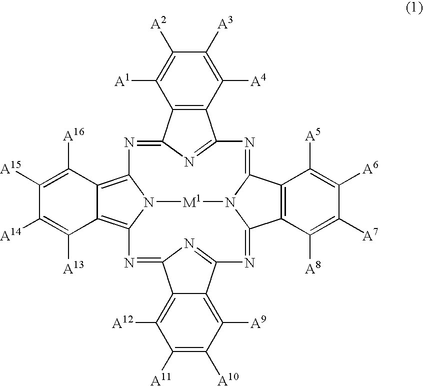
wherein A¹ to A¹⁶ each independently represent a hydrogen atom, a halogen atom, a hydroxyl group, an amino group, a hydroxysulfonyl group, an aminosulfonyl group, or a substituent having 1 to 20 carbon atoms optionally containing a nitrogen, sulfur, oxygen, or halogen atom, and adjacent two substituents may be connected to each other through a linking group, provided that at least four of A¹ to A¹⁶ represent a substituent through a sulfur or nitrogen atom; and M¹ represents copper or vanadium oxide.

The third invention provides an optical filter in which, in the first or second invention, the coloring matter having an absorption maximum in a wavelength region of 570 to 610 nm is a tetraazaporphyrin coloring matter represented by formula (2): 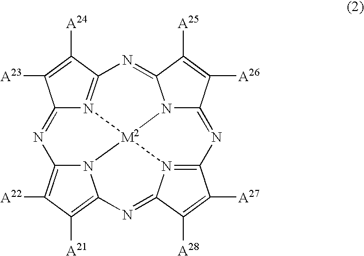
wherein A²¹ to A²⁸ each independently represent a hydrogen atom, a halogen atom, a nitro group, a cyano group, a hydroxy group, an amino group, a carboxyl group, a sulfonic acid group, or an alkyl, halogenoalkyl, alkoxy, alkoxyalkoxy, aryloxy, monoalkylamino, dialkylamino, aralkyl, aryl, heteroaryl, alkylthio, or arylthio group having 1 to 20 carbon atoms; A²¹ and A²², A²³ and A²⁴, A²⁵ and A²⁶, and A²⁷ and A²⁸ each independently may form a ring except for an aromatic ring through a linking group; and M² represents two hydrogen atoms, a divalent metal atom, a trivalent monosubstitued metal atom, a tetravalent disubstituted metal atom, or an oxymetal atom.

The fourth invention provides an optical filter in which, in any of the first to third inventions, said ionic coloring matter compound is a diimmonium coloring matter or a squarylium coloring matter.

The fifth invention provides an optical filter in which, in the first to fourth inventions, said ionic coloring matter compound is a diimmonium coloring matter represented by general formula (3): 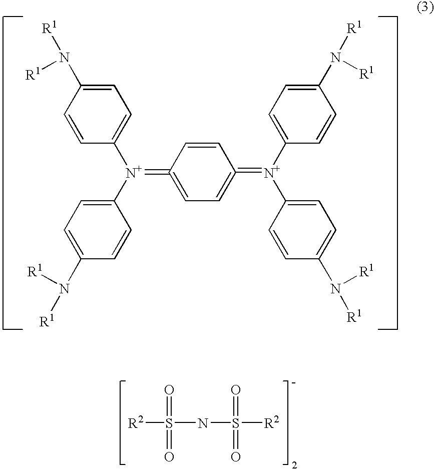
wherein R¹s each independently represent a hydrogen atom, a halogen atom, a nitro group, a cyano group, a thiocyanate group, a cyanate group, an acyl group, a carbamoyl group, an alkylaminocarbonyl group, a substituted or unsubstituted alkoxycarbonyl group, a substituted or unsubstituted aryloxycarbonyl group, a substituted or unsubstituted alkyl group, a substituted or unsubstituted aryl group, a substituted or unsubstituted alkoxy group, a substituted or unsubstituted aryloxy group, a substituted or unsubstituted alkylthio group, a substituted or unsubstituted arylthio group, a substituted or unsubstituted alkylamino group, a substituted or unsubstituted arylamino group, a substituted or unsubstituted alkylcarbonylamino group, or a substituted or unsubstituted arylcarbonylamino group, provided that at least one of R¹s in general formula (3) represents a branched-chain alkyl group; R²s each independently represent a hydrogen atom, a halogen atom, a nitro group, a cyano group, a thiocyanate group, a cyanate group, an acyl group, a carbamoyl group, an alkylaminocarbonyl group, a substituted or unsubstituted alkoxycarbonyl group, a substituted or unsubstituted aryloxycarbonyl group, a substituted or unsubstituted alkyl group, a substituted or unsubstituted aryl group, a substituted or unsubstituted alkoxy group, a substituted or unsubstituted aryloxy group, a substituted or unsubstituted alkylthio group, a substituted or unsubstituted arylthio group, a substituted or unsubstituted alkylamino group, a substituted or unsubstituted arylamino group, a substituted or unsubstituted alkylcarbonylamino group, or a substituted or unsubstituted arylcarbonylamino group; and the anion component is a sulfonylimide-containing monovalent anion.

The sixth invention provides an optical filter in which, in the fifth invention, said branched-chain alkyl group in R¹ in general formula (3) has 2 to 8 carbon atoms.

The seventh invention provides an optical filter in which, in the fifth or sixth invention, said branched-chain alkyl group in R¹ in general formula (3) represents 1-methylethyl, 1,1-dimethylethyl, 1-methylpropyl, 2-methylpropyl, 1-methylbutyl, 2-methylbutyl, 3-methylbutyl, or 2-ethylbutyl group.

The eighth invention provides an optical filter in which, in any of fifth to seventh inventions, R² in general formula (3) represents a substituted or unsubstituted alkyl group or a substituted or unsubstituted aryl group.

The ninth invention provides an optical filter in which, in any of the fifth to eighth inventions, R² in general formula (3) represents an alkyl group containing a halogen as a substituent, or an aryl group.

The tenth invention provides an optical filter in which, in any of the first to ninth inventions, said coloring matter layer is formed of a coloring matter having an absorption maximum wavelength in a wavelength region of 800 to 1100 nm and a coloring matter having an absorption maximum in a wavelength region of 570 to 610 nm contained in a transparent resin.

The eleventh invention provides an optical filter in which, in any of the first to tenth inventions, at least one of a coloring matter having an absorption maximum wavelength in a wavelength region of 380 to 570 nm and a coloring matter having an absorption maximum in a wavelength region of 610 to 780 nm is further contained in said coloring matter layer.

The twelfth invention provides an optical filter in which, in any of the first to eleventh inventions, one layer or two or more layers having any one or at least two of electromagnetic wave shielding functions, antireflection functions, anti-dazzling functions, antifouling functions, and ultraviolet absorption functions are further provided.

The thirteenth invention provides a display comprising an optical filter according to any one of the first to twelfth inventions provided on a display in its viewer side.

### BRIEF DESCRIPTION OF THE DRAWINGS

FIG. 1 is a schematic cross-sectional view showing one embodiment of the optical filter according to the present invention; and

FIG. 2 is a schematic cross-sectional view showing one embodiment of the optical filter according to the present invention and a plasma display comprising the optical filter provided on its viewer side.

### BEST MODE FOR CARRYING OUT THE INVENTION

<Optical filter (part 1)>

The optical filter according to the present invention comprises at least a coloring matter layer comprising a coloring matter having an absorption maximum wavelength in a wavelength region of 800 to 1100 nm and a coloring matter having an absorption maximum in a wavelength region of 570 to 610 nm contained in an identical layer, characterized in that said coloring matter layer does not substantially contain two or more ionic coloring matter compounds different from each other in cation part.

Coloring matter layer

The coloring matter layer in the optical filter according to the present invention comprises a coloring matter having an absorption maximum wavelength in a wavelength region of 800 to 1100 nm (hereinafter often referred to as “first coloring matter”) and a coloring matter having an absorption maximum in a wavelength region of 570 to 610 nm (hereinafter often referred to as “second coloring matter”) contained in an identical layer. In this case, the coloring matter layer does not substantially contain two or more ionic coloring matter compounds different from each other in cation part. The ionic coloring matter compound may be used (i) as a first coloring matter, or (ii) as a second coloring matter, or (iii), when a coloring matter other than the above two coloring matters (hereinafter often referred to as “third coloring matter”) is present, as the third coloring matter. However, it is important that substantially two or more ionic compounds different from each other in cation part are not contained in an identical coloring matter layer. In general, for example, diimmonium coloring matters, squalirium coloring matters, cyanine coloring matters, and methine coloring matters are ionic coloring matter compounds. Therefore, preferably, these ionic coloring matter compounds different from each other in cation part are not simultaneously contained in an identical coloring matter layer.

All the first coloring matter, the second coloring matter, and the third coloring matter are not an ionic coloring matter compound, and, thus, an optical filter in which any ionic coloring matter compound is not substantially present in the identical coloring matter layer (that is, an optical filter in which no ionic coloring matter compound is contained) also corresponds to the optical filter according to the present invention. An optical filter in which two or more ionic compounds different from each other in cation part are disadvantageously unavoidably present in an identical coloring matter layer or an optical filter in which the total amount, based on the ionic coloring matter compound having the highest content, of the other types of ionic compounds different from each other in cation part is relatively small and, consequently, the presence of the other types of ionic coloring matter compounds is substantially negligible (for example, the total amount, based on 100% by mass of ionic coloring matter compounds having the highest content, of other types of ionic coloring matter compounds is not more than 10% by mass, particularly not more than 5% by mass) also correspond to the optical filter according to the present invention.

Coloring matter having absorption maximum wavelength in a wavelength region of 800 to 1100 nm (first coloring matter)

The coloring matter having absorption maximum wavelength in a wavelength region of 800 to 1100 nm (first coloring matter) may be any one or at least two coloring matters so far as a requirement that two or more ionic coloring matter compounds different from each other in cation part are not contained in an identical coloring matter layer is satisfied.

Examples of preferred first coloring matters include (i) phthalocyanine coloring matters, (ii) diimmonium coloring matters, (iii) squalirium coloring matters, and (iv) dithiol coloring matters. Among them, (i) phthalocyanine coloring matters and (ii) diimmonium coloring matters are particularly preferred. Further, two or more coloring matters selected from among groups (i) to (iv) may be used in combination. In the present invention, the same type of coloring matter compounds (that is, for example, coloring matter compounds classified into the same group in the above (i) to (iv) and the following (v) to (viii)) are regarded as the same type of compounds. Accordingly, when a plurality of compounds belonging to the same compound group in (i) to (xvi) are used, in the present invention, this is regarded as the use of one type of coloring matter compound.

(i) Any compound may be used as the phthalocyanine coloring matter. Specific examples of particularly preferred phthalocyanine coloring matters include compounds represented by formula (1): 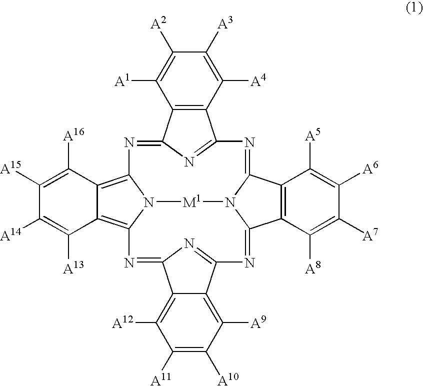
wherein A¹ to A¹⁶ each independently represent a hydrogen atom, a halogen atom, a hydroxyl group, an amino group, a hydroxysulfonyl group, an aminosulfonyl group, or a substituent having 1 to 20 carbon atoms optionally containing a nitrogen, sulfur, oxygen, or halogen atom, and adjacent two substituents may be connected to each other through a linking group, provided that at least four of A¹ to A¹⁶ represent a substituent through a sulfur or nitrogen atom; and M¹ represents copper or vanadium oxide.

The phthalocyanine compound (i) in the present invention is not particularly limited so far as predetermined requirements for substituents A¹ to A¹⁶ and M¹ are satisfied in the compounds represented by formula (1).

Preferred halogen atoms include fluorine, chlorine, bromine, and iodine atoms. Among them, fluorine and chlorine atoms are particularly preferred.

Substituents having 1 to 20 carbon atoms optionally containing a nitrogen, sulfur, oxygen, or halogen atom include straight-chain, branched-chain or cyclic alkyl groups such as methyl, ethyl, n-propyl, iso-propyl, n-butyl, iso-butyl, sec-butyl, t-butyl, n-pentyl, n-hexyl, cyclohexyl, n-heptyl, n-octyl, and 2-ethylhexyl groups, alkyl groups containing a heteroatom or an aromatic ring such as methoxymethyl, phenoxymethyl, diethylaminomethyl, phenylthiomethyl, benzyl, p-chlorobenzyl, and p-methoxybenzyl groups, and aryl groups such as phenyl, p-methoxyphenyl, p-t-butylphenyl, and p-chlorophenyl groups,

alkoxy groups such as methoxy, ethoxy, n-propyloxy, iso-propyloxy, n-butyloxy, iso-butyloxy, sec-butyloxy, t-butyloxy, n-pentyloxy, n-hexyloxy, cyclohexyloxy, n-heptyloxy, n-octyloxy, and 2-ethylhexyloxy groups, and alkoxyalkoxy groups such as methoxyethoxy, and phenoxyethoxy groups, and hydroxyalkoxy groups such as hydroxyethoxy groups, aralkyloxy groups such as benzyloxy, p-chlorobenzyloxy, and p-methoxybenzyloxy groups, and aryloxy groups such as phenoxy, p-methoxyphenoxy, p-t-butylphenoxy, p-chlorophenoxy, o-aminophenoxy, and p-diethylaminophenoxy groups,

alkylcarbonyloxy groups such as acetyloxy, ethylcarbonyloxy, n-propylcarbonyloxy, iso-propylcarbonyloxy, n-butylcarbonyloxy, iso-butylcarbonyloxy, sec-butylcarbonyloxy, t-butylcarbonyloxy, n-pentylcarbonyloxy, n-hexylcarbonyloxy, cyclohexylcarbonyloxy, n-heptylcarbonyloxy, 3-heptylcarbonyloxy, and n-octylcarbonyloxy groups and arylcarbonyloxy groups such as benzoyloxy, p-chlorobenzoyloxy, p-methoxybenzoyloxy, p-ethoxybenzoyloxy, p-t-butylbenzoyloxy, p-trifluoromethylbenzoyloxy, m-trifluoromethylbenzoyloxy, o-aminobenzoyloxy, and p-diethylaminobenzoyloxy groups,

alkylthio groups such as methylthio, ethylthio, n-propylthio, iso-propylthio, n-butylthio, iso-butylthio, sec-butylthio, t-butylthio, n-pentylthio, n-hexylthio, cyclohexylthio, n-heptylthio, n-octylthio and 2-ethylhexylthio groups, and aralkylthio groups such as benzylthio, p-chlorobenzylthio, and p-methoxybenzylthio groups, and arylthio groups such as phenylthio, p-methoxyphenylthio, p-t-butylphenylthio, p-chlorophenylthio, o-aminophenylthio, o-(n-octylamino) phenylthio, o-(benzylamino) phenylthio, o-(methylamino) phenylthio, p-diethylaminophenylthio, and naphthylthio groups,

alkylamino groups such as methylamino, ethylamino, n-propylamino, n-butylamino, sec-butylamino, n-pentylamino, n-hexylamino, n-heptylamino, n-octylamino, 2-ethylhexylamino, dimethylamino, diethylamino, di-n-propylamino, di-n-butylamino, di-sec-butylamino, di-n-pentylamino, di-n-hexylamino, di-n-heptylamino groups, and di-n-octylamino, and arylamino groups such as phenylamino, p-methylphenylamino, p-t-butylphenylamino, diphenylamino, di-p-methylphenylamino, and di-p-t-butylphenylamino groups, and alkylcarbonylamino groups such as acetylamino, ethylcarbonylamino, n-propylcarbonylamino, iso-propylcarbonylamino, n-butylcarbonylamino, iso-butylcarbonylamino, sec-butylcarbonylamino, t-butylcarbonylamino, n-pentylcarbonylamino, n-hexylcarbonylamino, cyclohexylcarbonylamino, n-heptylcarbonylamino, 3-heptylcarbonylamino groups, and n-octylcarbonylamino, and arylcarbonylamino groups such as benzoylamino, p-chlorobenzoylamino, p-methoxybenzoylamino, p-methoxybenzoylamino, p-t-butylbenzoylamino, p-chlorobenzoylamino, p-trifluoromethylbenzoylamino, and m-trifluoromethylbenzoylamino groups,

alkoxycarbonyl groups such as hydroxycarbonyl, methoxycarbonyl, ethoxycarbonyl, n-propyloxycarbonyl, iso-propyloxycarbonyl, n-butyloxycarbonyl, iso-butyloxycarbonyl, sec-butyloxycarbonyl, t-butyloxycarbonyl, n-pentyloxycarbonyl, n-hexyloxycarbonyl, cyclohexyloxycarbonyl, n-heptyloxycarbonyl, n-octyloxycarbonyl, and 2-ethylhexyloxycarbonyl groups, and alkoxyalkoxycarbonyl groups such as methoxyethoxycarbonyl, phenoxyethoxycarbonyl, and hydroxyethoxy carbonyl groups and aryloxycarbonyl groups such as benzyloxycarbonyl, phenoxycarbonyl, p-methoxyphenoxycarbonyl, p-t-butylphenoxycarbonyl, p-chlorophenoxycarbonyl, o-aminophenoxycarbonyl, and p-diethylaminophenoxycarbonyl groups,

alkylaminocarbonyl groups such as aminocarbonyl, methylaminocarbonyl, ethylaminocarbonyl, n-propylaminocarbonyl, n-butylaminocarbonyl, sec-butylaminocarbonyl, n-pentylaminocarbonyl, n-hexylaminocarbonyl, n-heptylaminocarbonyl, n-octylaminocarbonyl, 2-ethylhexylaminocarbonyl, dimethylaminocarbonyl, diethylaminocarbonyl, di-n-propylaminocarbonyl, di-n-butylaminocarbonyl, di-sec-butylaminocarbonyl, di-n-pentylaminocarbonyl, di-n-hexylaminocarbonyl, di-n-heptylaminocarbonyl, and di-n-octylaminocarbonyl groups, and arylaminocarbonyl groups such as phenylaminocarbonyl, p-methylphenylaminocarbonyl, p-t-butylphenylaminocarbonyl, diphenylaminocarbonyl, di-p-methylphenylaminocarbonyl, and di-p-t-butylphenylaminocarbonyl groups, and

alkylaminosulfonyl groups such as methylaminosulfonyl, ethylaminosulfonyl, n-propylaminosulfonyl, n-butylaminosulfonyl, sec-butylaminosulfonyl, n-pentylaminosulfonyl, n-hexylaminosulfonyl, n-heptylaminosulfonyl, n-octylaminosulfonyl, 2-ethylhexylaminosulfonyl, dimethylaminosulfonyl, diethylaminosulfonyl, di-n-propylaminosulfonyl, di-n-butylaminosulfonyl, di-sec-butylaminosulfonyl, di-n-pentylaminosulfonyl, di-n-hexylaminosulfonyl, di-n-heptylaminosulfonyl, and di-n-octylaminosulfonyl groups and arylaminosulfonyl groups such as phenylaminosulfonyl, p-methylphenylaminosulfonyl, p-t-butylphenylaminosulfonyl, diphenylaminosulfonyl, di-p-methylphenylaminosulfonyl, and di-p-t-butylphenylaminosulfonyl groups.

Substituents in which two adjacent substituents may be connected to each other through a linking group include the following substituents which can form a five- or six-membered ring through a heteroatom, for example, as represented by the following formulae.

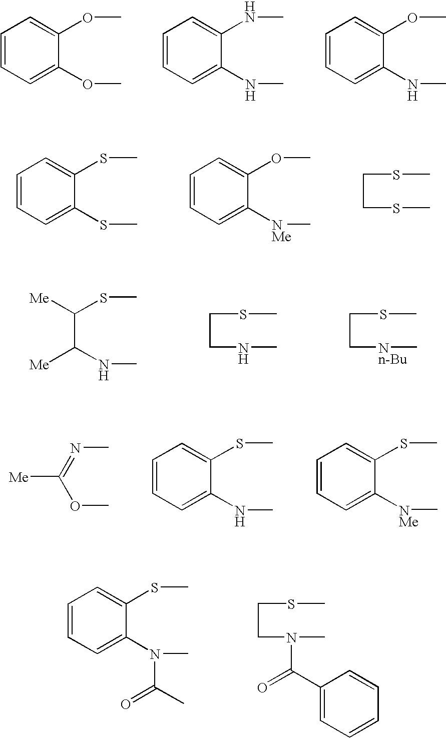

Examples of the “substituent through a sulfur or nitrogen atom” in phthalocyanine compounds represented by formula (1) include amino and aminosulfonyl groups, and the above alkylthio, arylthio, alkylamino, arylamino, alkylcarbonylamino, and arylcarbonylamino groups. The absorption wavelength of phthalocyanine is generally around 600 to 750 nm. However, when the substituent through a sulfur or nitrogen atom is introduced, the absorption wavelength is shifted toward a longer wavelength and can be brought to not less than 800 nm. To this end, at least four of A¹ to A¹⁶ are a substituent through a sulfur atom and/or a substituent through a nitrogen atom, and, more preferably, eight or more of A¹ to A¹⁶ are a substituent through a sulfur atom and/or a substituent through a nitrogen atom.

Any compound may be used as (ii) diimmonium coloring matter. Specific examples of particularly preferred diimmonium coloirng matters include compounds represented by formula (3): 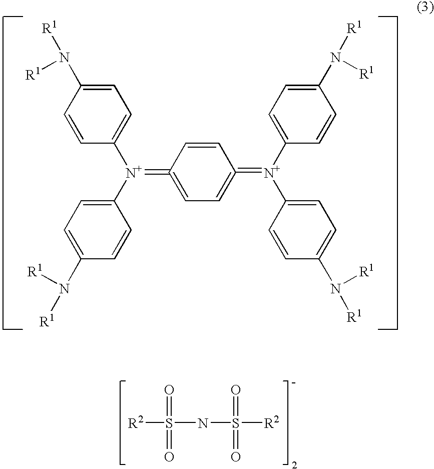
wherein R¹s each independently represent a hydrogen atom, a halogen atom, a nitro group, a cyano group, a thiocyanate group, a cyanate group, an acyl group, a carbamoyl group, an alkylaminocarbonyl group, a substituted or unsubstituted alkoxycarbonyl group, a substituted or unsubstituted aryloxycarbonyl group, a substituted or unsubstituted alkyl group, a substituted or unsubstituted aryl group, a substituted or unsubstituted alkoxy group, a substituted or unsubstituted aryloxy group, a substituted or unsubstituted alkylthio group, a substituted or unsubstituted arylthio group, a substituted or unsubstituted alkylamino group, a substituted or unsubstituted arylamino group, a substituted or unsubstituted alkylcarbonylamino group, or a substituted or unsubstituted arylcarbonylamino group, provided that at least one of R¹s in general formula (3) represents a branched-chain alkyl group; R²s each independently represent a hydrogen atom, a halogen atom, a nitro group, a cyano group, a thiocyanate group, a cyanate group, an acyl group, a carbamoyl group, an alkylaminocarbonyl group, a substituted or unsubstituted alkoxycarbonyl group, a substituted or unsubstituted aryloxycarbonyl group, a substituted or unsubstituted alkyl group, a substituted or unsubstituted aryl group, a substituted or unsubstituted alkoxy group, a substituted or unsubstituted aryloxy group, a substituted or unsubstituted alkylthio group, a substituted or unsubstituted arylthio group, a substituted or unsubstituted alkylamino group, a substituted or unsubstituted arylamino group, a substituted or unsubstituted alkylcarbonylamino group, or a substituted or unsubstituted arylcarbonylamino group; and the anion component is a sulfonylimide-containing monovalent anion.

R¹ and R² may be the same or different, and a plurality of R¹s each may be the same or different. Likewise, a plurality of R²s each may be the same or different.

The diimmonium coloring matter represented by general formula (3) in the present invention is stable and highly durable among the reactive group-containing resins and thus can stably maintain predetermined near infrared absorption characteristics for a long period of time. Therefore, the mixing amount of the coloring matter necessary for maintaining the predetermined near infrared absorption characteristics for a long period of time can be reduced as compared with that in the prior art technique. This can also offer the effect of improving the transmittance of visible light.

Substituents R¹

R¹ in general formula (3) will be described in more detail.

When R¹ contains a carbon atom, the number of carbon atoms in R¹ is preferably 1 to 20, particularly preferably 1 to 10.

Halogen atoms include fluorine, chlorine, bromine, and iodine atoms.

Acyl atoms include acetyl, ethylcarbonyl, propylcarbonyl, butylcarbonyl, pentylcarbonyl, hexylcarbonyl, benzoyl, and p-t-butylbenzoyl.

Examples of substituted or unsubstituted alkyl groups include straight-chain, branched-chain or cyclic hydrocarbon groups having 1 to 20 carbon atoms such as methyl, ethyl, n-propyl, iso-propyl, n-butyl, iso-butyl, sec-butyl, t-butyl, n-pentyl, iso-pentyl, neo-pentyl, 1,2-dimethylpropyl, n-hexyl, cyclo-hexyl, 1,3-dimethylbutyl, 1-iso-propylpropyl, 1,2-dimethylbutyl, n-heptyl, 1,4-dimethylpentyl, 2-methyl-1-iso-propylpropyl, 1-ethyl-3-methylbutyl, n-octyl, 2-ethylhexyl, 3-methyl-1-iso-propylbutyl, 2-methyl-1-iso-propyl, 1-t-butyl-2-methylpropyl, n-nonyl, and 3,5,5-trimethylhexyl groups, and alkoxyalkyl groups such as methoxymethyl, methoxyethyl, ethoxyethyl, propoxyethyl, butoxyethyl, 3-methoxypropyl, 3-ethoxypropyl, methoxyethoxyethyl, ethoxyethoxyethyl, dimethoxymethyl, diethoxymethyl, dimethoxyethyl, and diethoxyethyl groups, and halogenated alkyl groups such as alkoxyalkoxyalkyl, alkoxyalkoxyalkoxyalkyl, chloromethyl, 2,2,2-trichloroethyl, trifluoromethyl, and 1,1,1,3,3,3-hexafluoro-2-propyl groups, and alkylaminoalkyl groups having 2 to 20 carbon atoms, and dialkylaminoalkyl, alkoxycarbonylalkyl, alkylaminocarbonylalkyl, alkoxysulfonylalkyl groups.

At least one of R¹s in general formula (3) according to the present invention is a branched-chain alkyl group. That is, the number of branched-chain alkyl groups as R¹ in general formula (3) according to the present invention is 1 or more, and the upper limit thereof is 8, preferably 4 to 8. When there are a plurality of branched-chain alkyl groups, the branched-chain alkyl groups may be the same or different.

Examples of substituted or unsubstituted alkoxy groups include straight-chain or branched-chain alkoxy groups having 1 to 20 carbon atoms such as methoxy, ethoxy, n-propyloxy, iso-propyloxy, n-butyloxy, iso-butyloxy, sec-butyloxy, t-butyloxy, n-pentyloxy, iso-pentyloxy, neo-pentyloxy, 1,2-dimethyl-propyloxy, n-hexyloxy, cyclo-hexyloxy, 1,3-dimethylbutyloxy, 1-iso-propylpropyloxy, 1,2-dimethylbutyloxy, n-heptyloxy, 1,4-dimethylpentyloxy, 2-methyl-1-iso-propylpropyloxy, 1-ethyl-3-methylbutyloxy, n-octyloxy, 2-ethylhexyloxy, 3-methyl-1-iso-propylbutyloxy, 2-methyl-1-iso-propyloxy, 1-t-butyl-2-methylpropyloxy, and n-nonyloxy groups, and alkoxyalkoxy groups such as methoxymethoxy, methoxyethoxy, ethoxyethoxy, propoxyethoxy, butoxyethoxy, 3-methoxypropyloxy, 3-ethoxypropyloxy, dimethoxymethoxy, diethoxymethoxy, dimethoxyethoxy, and diethoxyethoxy groups, and alkoxyalkoxyalkoxy groups such as methoxyethoxyethoxy, ethoxyethoxyethoxy, and butyloxyethoxyethoxy groups, and halogenated alkoxy groups such as alkoxyalkoxyalkoxyalkoxy, chloromethoxy, 2,2,2-trichloroethoxy, trifluoromethoxy, and 1,1,1,3,3,3-hexafluoro-2-propyloxy groups, and alkylaminoalkoxy groups such as dimethylaminoethoxy and diethylaminoethoxy groups, and dialkylaminoalkoxy group.

Examples of substituted or unsubstituted aryl groups include halogenated phenyl groups such as phenyl, chlorophenyl, dichlorophenyl, trichlorophenyl, bromophenyl, fluorophenyl, pentafluorophenyl, and phenyl iodide groups, alkyl derivative-substituted phenyl groups such as tolyl, xylyl, mesityl, ethylphenyl, dimethylethylphenyl, iso-propylphenyl, t-butylphenyl, t-butylmethylphenyl, octylphenyl, nonylphenyl, and trifluoromethylphenyl groups, alkoxy-substituted phenyl groups such as methoxyphenyl, ethoxyphenyl, propoxyphenyl, hexyloxyphenyl, cyclohexyloxyphenyl, octyloxyphenyl, 2-ethylhexyloxyphenyl, 3,5,5-trimethylhexyloxyphenyl, methylethoxyphenyl, dimethoxyphenyl, 1-ethoxy-4-methoxyphenyl, chloromethoxyphenyl, ethoxyethoxyphenyl, and ethoxyethoxyethoxyphenyl groups, alkylthio-substituted phenyl groups such as methylthiophenyl, ethylthiophenyl, t-butylthiophenyl, di-tert-buthylthiophenyl, 2-methyl-1-ethylthiophenyl, and 2-butyl-1-methylthiophenyl groups, alkylaminophenyl groups such as N,N-dimethylaminophenyl, N,N-diethylaminophenyl, N,N-dipropylaminophenyl, N,N-dibutylaminophenyl, N,N-diamylaminophenyl, N,N-dihexylaminophenyl, N-methyl-N-ethylaminophenyl, N-butyl-N-ethylaminophenyl, N-hexyl-N-ethylaminophenyl, 4-(N,N-dimethylamino)-ethylphenyl, 4-(N,N-diethylamino)-methylphenyl, 3-(N,N-dimethylamino)-ethylphenyl, and 2-(N,N-dimethylamino)-ethylphenyl groups, halogenated naphthyl groups such as naphthyl, chloronaphthyl, dichloronaphthyl, trichloronaphthyl, bromonaphthyl, fluoronaphthyl, pentafluoronaphthyl, and naphthyl iodide groups, alkyl derivative-substituted naphthyl groups such as ethylnaphthyl, dimethylethylnaphthyl, iso-propylnaphthyl, t-butylnaphthyl, t-butylmethylnaphthyl, octylnaphthyl, nonylnaphthyl, and trifluoromethylnaphthyl groups, alkoxy-substituted naphthyl groups such as methoxynaphthyl, ethoxynaphthyl, propoxynaphthyl, hexyloxynaphthyl, cyclohexyloxynaphthyl, octyloxynaphthyl, 2-ethylhexyloxynaphthyl, 3,5,5-trimethylhexyloxynaphthyl, methylethoxynaphthyl, dimethoxynaphthyl, chloromethoxynaphthyl, ethoxyethoxynaphthyl, and ethoxyethoxyethoxynaphthyl groups, alkylthio-substituted naphthyl groups such as methylthionaphthyl, ethylthionaphthyl, t-butylthionaphthyl, methylethylthionaphthyl, and butylmethylthionaphthyl groups, alkylaminonaphthyl groups, such as N,N-dimethylaminonaphthyl, N,N-diethylaminonaphthyl, N,N-dipropylaminonaphthyl, N,N-dibutylaminonaphthyl, N,N-diamylaminonaphthyl, N,N-dihexylaminonaphthyl, N-methyl-N-ethylaminonaphthyl, N-butyl-N-ethylaminonaphthyl, N-hexyl-N-ethylaminonaphthyl, 4-(N,N-dimethylamino)-ethylnaphthyl, 4-(N,N-diethylamino)-methylnaphthyl, 3-(N,N-dimethylamino)-ethylnaphthyl, and 2-(N,N-dimethylamino)-ethyinaphthyl groups, and pyridyl, piperidyl, thiophenyl, imidazolyl, pyrrolidyl, and furyl groups.

Examples of substituted or unsubstituted aryloxy groups include phenoxy, naphthoxy, and alkylphenoxy groups.

Examples of substituted or unsubstituted alkylthio groups include straight-chain or branched-chain alkylthio groups having 1 to 20 carbon atoms such as methylthio, ethylthio, n-propylthio, iso-propylthio, n-butylthio, iso-butylthio, sec-butylthio, t-butylthio, n-pentylthio, iso-pentylthio, neo-pentylthio, 1,2-dimethylpropylthio, n-hexylthio, cyclo-hexylthio, 1,3-dimethylbutylthio, 1-iso-propylpropylthio, 1,2-dimethylbutylthio, n-heptylthio, 1,4-dimethylpentylthio, 2-methyl-1-iso-propylpropylthio, 1-ethyl-3-methylbutylthio, n-octylthio, 2-ethylhexylthio, 3-methyl-1-iso-propylbutylthio, 2-methyl-1-iso-propylthio,. 1-t-butyl-2-methylpropylthio, and n-nonylthio groups, alkoxyalkylthio groups such as methoxymethylthio, methoxyethylthio, ethoxyethylthio, propoxyethylthio, butoxyethylthio, 3-methoxypropylthio, 3-ethoxypropylthio, methoxyethoxyethylthio, ethoxyethoxyethylthio, dimethoxymethylthio, diethoxymethylthio, dimethoxyethylthio, and diethoxyethylthio groups, halogenated alkylthio groups such as alkoxyalkoxyalkylthio, alkoxyalkoxyalkoxyalkylthio, chloromethylthio, 2,2,2-trichloroethylthio, trifluoromethylthio, and 1,1,1,3,3,3-hexafluoro-2-propylthio groups, and alkylaminoalkylthio and dialkylaminoalkylthio groups such as dimethylaminoethylthio and diethylaminoethylthio groups.

Examples of substituted or unsubstituted arylthio groups include phenylthio, naphthylthio, and alkylphenylthio groups.

Examples of substituted or unsubstituted alkoxycarbonyl groups include straight-chain or branched-chain alkyloxycarbonyl groups having 2 to 20 carbon atoms such as methoxycarbonyl, ethoxycarbonyl, n-propoxycarbonyl, iso-propoxycarbonyl, n-butoxycarbonyl, iso-butoxycarbonyl, sec-butoxycarbonyl, t-butoxycarbonyl, n-pentyloxycarbonyl, iso-pentyloxycarbonyl, neo-pentyloxycarbonyl, 1,2-dimethyl-propyloxycarbonyl, n-hexyloxycarbonyl, cyclo-hexyloxycarbonyl, 1,3-dimethyl-butyloxycarbonyl, 1-iso-propylpropyloxycarbonyl, 1,2-dimethylbutyloxycarbonyl, n-heptyloxycarbonyl, 1,4-dimethylpentyloxycarbonyl, 2-methyl-1-iso-propylpropyloxycarbonyl, 1-ethyl-3-methylbutyloxycarbonyl, n-octyloxycarbonyl, 2-ethylhexyloxycarbonyl, 3-methyl-1-iso-propylbutyloxycarbonyl, 2-methyl-1-iso-propyloxycarbonyl, 1-t-butyl-2-methylpropyloxycarbonyl, and n-nonyloxycarbonyl groups, and alkoxyalkoxycarbonyl groups such as methoxymethoxycarbonyl, methoxyethoxycarbonyl, ethoxyethoxycarbonyl, propoxyethoxycarbonyl, butoxyethoxycarbonyl, γ-methoxypropoxycarbonyl, γ-ethoxypropoxycarbonyl, methoxyethoxyethoxycarbonyl, ethoxyethoxyethoxycarbonyl, dimethoxymethoxycarbonyl, diethoxymethoxycarbonyl, dimethoxyethoxycarbonyl, and diethoxyethoxycarbonyl groups, halogenated alkyloxycarbonyl groups such as alkoxyalkoxyalkoxycarbonyl, alkoxyalkoxyalkoxyalkoxycarbonyl, chloromethoxycarbonyl, 2,2,2-trichloroethoxycarbonyl, trifluoromethoxycarbonyl, and 1,1,1,3,3,3-hexafluoro-2-propoxycarbonyl groups, and alkylaminoalkyloxycarbonyl, dialkylaminoalkyloxycarbonyl, alkoxycarbonylalkyloxycarbonyl, alkylaminocarbonylalkyloxycarbonyl, alkoxysulfonylalkyloxycarbonyl, and alkylsulfonyloxycarbonyl groups having 3 to 20 carbon atoms.

Examples of substituted or unsubstituted aryloxycarbonyl groups include phenyloxycarbonyl, naphthyloxycarbonyl, tolyloxycarbonyl, xylyloxycarbonyl, and chlorophenyloxycarbonyl groups.

Examples of alkylaminocarbonyl groups include methylaminocarbonyl, ethylaminocarbonyl, n-propylaminocarbonyl, n-butylaminocarbonyl, sec-butylaminocarbonyl, n-pentylaminocarbonyl, n-hexylaminocarbonyl, n-heptylaminocarbonyl, n-octylaminocarbonyl, 2-ethylhexylaminocarbonyl, dimethylaminocarbonyl, ethylaminocarbonyl, di-n-propylaminocarbonyl, di-n-butylaminocarbonyl, di-sec-butylaminocarbonyl, di-n-pentylaminocarbonyl, di-n-hexylaminocarbonyl, di-n-heptylaminocarbonyl, and di-n-octylaminocarbonyl groups.

Examples of substituted or unsubstituted alkylamino groups include methylamino, ethylamino, n-propylamino, n-butylamino, sec-butylamino, n-pentylamino, n-hexylamino, n-heptylamino, n-octylamino, 2-ethylhexylamino, dimethylamino, diethylamino, di-n-propylamino, di-n-butylamino, di-sec-butylamino, di-n-pentylamino, di-n-hexylamino, di-n-heptylamino, and di-n-octylamino groups.

Examples of substituted or unsubstituted arylamino groups include phenylamino, p-methylphenylamino, p-t-butylphenylamino, diphenylamino, di-p-methylphenylamino, and di-p-t-butylphenylamino groups.

Examples of substituted or unsubstituted alkylcarbonylamino groups include acetylamino, ethylcarbonylamino, n-propylcarbonylamino, iso-propylcarbonylamino, n-butylcarbonylamino, iso-butylcarbonylamino, sec-butylcarbonylamino, t-butylcarbonylamino, n-pentylcarbonylamino, n-hexylcarbonylamino, cyclohexylcarbonylamino, n-heptylcarbonylamino, 3-heptylcarbonylamino, and n-octylcarbonylamino groups.

Examples of substituted or unsubstituted arylcarbonylamino groups include benzoylamino, p-chlorobenzoylamino, p-methoxybenzoylamino, p-t-butylbenzoylamino, p-trifluoromethylbenzoylamino, and m-trifluoromethylbenzoylamino groups.

Among them, substituted or unsubstituted alkyl groups and substituted or unsubstituted aryl groups are preferred, and ethyl, n-propyl, n-butyl, n-pentyl, ethylphenyl, and dimethylethylphenyl groups are particularly preferred.

Branched-chain alkyl group

At least one of R¹ in general formula (3) represents a branched-chain alkyl group. Specific examples of particularly preferred branched-chain alkyl groups include branched-chain alkyl groups having 1 to 20 carbon atoms such as 1-methylethyl (i-propyl), 1,1-dimethylethyl (t-butyl), 1-methylpropyl (sec-butyl), 1,1-dimethylpropyl, 2-methylpropyl (iso-butyl), 1,2-dimethylpropyl, 2,2-dimethylpropyl, 1-methylbutyl, 2-methylbutyl, 3-methylbutyl (iso-amyl), 1,1-dimethylbutyl, 2,2-dimethylbutyl, 3,3-dimethylbutyl, 1,2-dimethylbutyl, and 2-ethylbutyl groups, preferably, branched-chain alkyl groups having 2 to 8 carbon atoms. Among them, for example, 1-methylethyl, 1,1-dimethylethyl, 1-methylpropyl, 2-methylpropyl, 1-methylbutyl, 2-methylbutyl, 3-methylbutyl, and 2-ethylbutyl groups are particularly preferred.

Substituents R²

Examples of R² include those exemplified in R¹. Specific examples of preferred R² include those exemplified above as preferred R¹.

Among them, (i) substituted or unsubstituted alkyl groups and (ii) substituted or unsubstituted aryl groups are preferred as R². Substituents include halogens, preferably chlorine and fluorine.

Specific preferred examples of (i) substituted or unsubstituted alkyl groups include substituted alkyl groups, particularly alkyl groups substituted by a phenyl group. For example, benzyl, 4-fluorobenzyl, and 2,4,6-fluorobenzyl are specific examples of preferred alkyl groups substituted by the phenyl group.

Specific examples of particularly preferred R² include halogenated alkyl groups such as chloromethyl, 2,2,2-trichloroethyl, trifluoromethyl, and 1,1,1,3,3,3-hexafluoro-2-propyl groups, and chlorophenyl, dichlorophenyl, trichlorophenyl, bromophenyl, fluorophenyl, pentafluorophenyl, benzyl, 4-fluorobenzyl, and 2,4,6-fluorobenzyl groups.

Synthesis of diimmonium coloring matter represented by general formula (3)

The compound represented by general formula (3) used in the near infrared absortion filter according to the present invention may be synthesized by any method. For example, the compound represented by general formula (3) can be synthesized by converting the NH₂ group at the end of the compound represented by general formula (4) to a predetermined R¹ group so as to satisfy the requirement represented by general formula (3). In the present invention, the compound represented by general formula (3) is suitably produced, for example, by the following method described in Japanese Patent Publication No. 25335/1968. Specifically, an amino compound represented by formula (4) produced by reducing a product obtained by Ullmann reaction between p-phenylenediamine and 1-chloro-4-nitrobenzene may be reacted with a halogenated compound corresponding to desired R¹ (for example, BrCH₂CH(CH₃)₂ when R¹ represents i-C₄H₉) in an organic solvent, preferably a water soluble polar solvent such as N,N-dimethylformamide (DMF), 1,3-dimethyl-2-imidazolidinone (DMI), or N-methyl-2-pyrrolidone (NMP) at 30 to 160° C., preferably 50 to 140° C., to give a compound in which all substituents R¹ are identical (hereinafter referred to as “wholly substituted compound”). When compounds other than the wholly substituted compound are synthesized, for example, when compounds wherein one of R¹s represents n-C₄H₉ and the seven remaining R¹ represent i-C₄H₉ are produced, an iso-butyl group is first introduced into seven out of eight R¹s by a reaction with a reagent (BrCH₂CH(CH₃)₂) in a predetermined number of moles (7 moles per mole of the amine compound represented by formula (4)), followed by a reaction with a corresponding reagent (BrC₄H₉) in a number of moles (one mole per mole of the amine compound represented by formula (4)) necessary for introducing the remaining substituent (n-butyl group).

Any compound other than the wholly substituted compound may be produced in the same manner as described above.

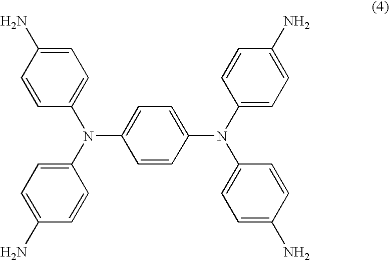

Thereafter, the compound synthesized above is oxidized in an organic solvent, preferably a water soluble polar solvent such as DMF, DMI, or NMP, at 0 to 100° C., preferably 5 to 70° C., with the addition of an oxidizing agent (for example, a silver salt) corresponding to an anion of the compound of formula (3). When the equivalent of the oxidizing agent is 2, the diimmonium salt compound of general formula (3) according to the present invention can be produced. When the equivalent of the oxidizing agent is one, a monovalent aminium salt compound is produced.

The compound of general formula (3) may also be synthesized by oxidizing the compound synthesized above with an oxidizing agent such as silver nitrate, silver perchlorate, or cupric chloride and then adding an acid or salt of a desired anion capable of producing the anion of general formula (3) to the reaction solution for salt exchange.

Any compound may be used as (iii) squarylium coloring matters. For example, coloring matters described, for example, in Japanese Patent Laid-Open Nos. 159776/2000, 25153/1995, 265077/2000, and 204310/1998 are suitable. Specific examples of squarylium coloring matters which are particularly preferred in the present invention include compounds represented by formula (5): 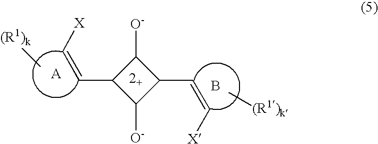
wherein R¹ and R^{1′}, which may be the same or different, represent a hydrogen atom, an optionally substituted alkylamino group, an optionally substituted dialkylamino group, an optionally substituted cycloalkylamino group, or an optionally substituted alkoxy group; X and X′, which may be the same or different, represent an active hydrogen-containing group; ring A and ring B each independently represent an aromatic carboxylic ring or an aromatic heterocyclic ring; and k and k′ are an integer of 1 to 4, provided that X and R¹, and X′ and R^{1′} each independently may be connected to each other to form a five- or six-membered ring.

Any compound may be used as (iv) dithiol coloring matters, and examples of suitable dithiol coloring matters include coloring matters described, for example, in Japanese Patent Laid-Open Nos. 139946/2003, 156991/1998, 303720/2002, and 54031/2005. In the present invention, specific examples of particularly preferred dithiol coloring materials include compounds represented by formula (6). 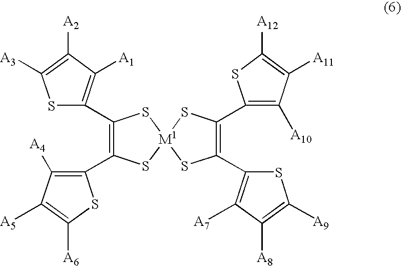
wherein A₁ to A₁₂ each independently represent a hydrogen atom, an optionally substituted alkyl group, an optionally substituted aryl group, an optionally substituted alkoxy group, an optionally substituted aryloxy group, an optionally substituted amino group, a nitro group, a halogen atom, or a cyano group, and two adjacent substituents may be connected to each other through a linking group; and M¹ represents nickel, palladium, platinum, cobalt, or copper.

Coloring matter having absorption maximum in wavelength region of 570 to 610 nm (second coloring matter)

Any one or at least two coloring matters may be used as the coloring matter having absorption maximum in wavelength region of 570 to 610 nm (second coloring matter) so far as the requirement that two or more ionic coloring matter compounds different from each other in cation part are not contained in an identical coloring matter layer is satisfied.

Examples of preferred second coloring matters include (v) tetraazaporphyrin coloring matters, (vi) cyanine coloring matters, (vii) methine coloring matters, and (viii) porphyrin coloring matters. Among them, (v) tetraazaporphyrin coloring matters are particularly preferred. Further, two or more coloring matters selected from among the above (v) to (viii) may be used in combination.

Specific preferred examples of (v) tetraazaporphyrin coloring matters include coloring matters represented by following formula (2): 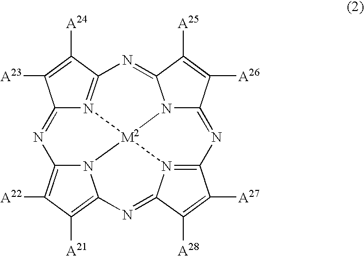
wherein A²¹ to A²⁸ each independently represent a hydrogen atom, a halogen atom, a nitro group, a cyano group, a hydroxy group, an amino group, a carboxyl group, a sulfonic acid group, or an alkyl, halogenoalkyl, alkoxy, alkoxyalkoxy, aryloxy, monoalkylamino, dialkylamino, aralkyl, aryl, heteroaryl, alkylthio, or arylthio group having 1 to 20 carbon atoms; A²¹ and A²², A²³ and A²⁴, A²⁵ and A²⁶, and A²⁷ and A²⁸ each independently may form a ring except for an aromatic ring through a linking group; and M² represents two hydrogen atoms, a divalent metal atom, a trivalent monosubstituted metal atom, a tetravalent disubstituted metal atom, or an oxymetal atom.

Specific examples of tetraazaporphyrin compounds represented by formula (2) will be described.

In formula (2), A²¹ to A²⁸ each independently may represent the following specific examples thereof: a hydrogen atom; halogen atoms such as fluorine, chlorine, bromine, and iodine; nitro; cyano; hydroxy; amino; carboxyl; sulfonic acid; straight-chain, branched-chain, or cyclic alkyl groups having 1 to 20 carbon atoms such as methyl, ethyl, n-propyl, iso-propyl, n-butyl, iso-butyl, sec-butyl, t-butyl, n-pentyl, 2-methylbutyl, 1-methylbutyl, neo-pentyl, 1,2-dimethylpropyl, 1,1-dimethylpropyl, cyclo-pentyl, n-hexyl, 4-methylpentyl, 3-methylpentyl, 2-methylpentyl, 1-methylpentyl, 3,3-dimethylbutyl, 2,3-dimethylbutyl, 1,3-dimethylbutyl, 2,2-dimethylbutyl, 1,2-dimethylbutyl, 1,1-dimethylbutyl, 3-ethylbutyl, 2-ethylbutyl, 1-ethylbutyl, 1,2,2-trimethylbutyl, 1,1,2-trimethylbutyl, 1-ethyl-2-methylpropyl, cyclo-hexyl, n-heptyl, 2-methylhexyl, 3-methylhexyl, 4-methylhexyl, 5-methylhexyl, 2,4-diemthylpentyl, n-octyl, 2-ethylhexyl, 2,5-dimethylhexyl, 2,5,5-trimethylpentyl, 2,4-dimethylhexyl, 2,2,4-trimethylpentyl, n-nonyl, 3,5,5-trimethylhexyl, n-decyl, 4-ethyloctyl, 4-ethyl-4,5-dimethylhexyl, n-undecyl, n-dodecyl, 1,3,5,7-tetramethyloctyl, 4-butyloctyl, 6,6-diethyloctyl, n-tridecyl, 6-methyl-4-butyloctyl, n-tetradecyl, n-pentadecyl, 3,5-dimethylheptyl, 2,6-dimethylheptyl, 2,4-dimethylheptyl, 2,2,5,5-tetramethylhexyl, 1-cyclo-pentyl-2,2-dimethylpropyl, and 1-cyclo-hexyl-2,2-dimethylpropyl groups; halogenoalkyl groups having 1 to 20 carbon atoms such as chloromethyl, dichloromethyl, fluoromethyl, trifluoromethyl, pentafluoroethyl, and nonafluorobutyl groups; alkoxy groups having 1 to 20 carbon atoms such as methoxy, ethoxy, n-propoxy, iso-propoxy, n-butoxy, iso-butoxy, sec-butoxy, t-butoxy, n-pentoxy, iso-pentoxy, neo-pentoxy, n-hexyloxy, and n-dodecyloxy groups; alkoxyalkoxy groups having 2 to 20 carbon atoms such as methoxyethoxy, ethoxyethoxy, 3-methoxypropyloxy, and 3-(iso-propyloxy)propyloxy groups; aryloxy groups having 6 to 20 carbon atoms such as phenoxy, 2-methylphenoxy, 4-methylphenoxy, 4-t-butylphenoxy, 2-methoxyphenoxy, and 4-iso-propylphenoxy groups; monoalkylamino groups having 1 to 20 carbon atoms such as methylamino, ethylamino, n-propylamino, n-butylamino, and n-hexylamino groups; dialkylamino groups having 2 to 20 carbon atoms such as dimethylamino, diethylamino, di-n-propylamino, di-n-butylamino, and N-methyl-N-cyclohexylamino groups; aralkyl groups having 7 to 20 carbon atoms such as benzyl, nitrobenzyl, cyanobenzyl, hydroxybenzyl, methylbenzyl, dimethylbenzyl, trimethylbenzyl, dichlorobenzyl, methoxybenzyl, ethoxybenzyl, trifluoromethylbenzyl, naphtylmethyl, nitronaphtylmethyl, cyanonaphtylmethyl, hydroxynaphtylmethyl, methylnaphtylmethyl, and trifluoromethylnaphtylmethyl groups; aryl groups having 6 to 20 carbon atoms such as phenyl, nitrophenyl, cyanophenyl, hydroxyphenyl, methylphenyl, dimethylphenyl, trimethylphenyl, dichlorophenyl, methoxyphenyl, ethoxyphenyl, trifluoromethylphenyl, N,N-dimethylaminophenyl, naphtyl, nitronaphtyl, cyanonaphtyl, hydroxynaphtyl, methylnaphtyl, and trifluoromethylnaphtyl groups; heteroaryl groups such as pyrrolyl, thienyl, furanyl, oxazoyl, isoxazoyl, oxadiazoyl, imidazoyl, benzoxazoyl, benzothiazoyl, benzoimidazoyl, benzofuranyl, and indoyl groups; alkylthio groups having 1 to 20 carbon atoms such as methylthio, ethylthio, n-propylthio, iso-propylthio, n-butylthio, iso-butylthio, sec-butylthio, t-butylthio, n-pentylthio, iso-pentylthio, 2-methylbutylthio, 1-methylbutylthio, neo-pentylthio, 1,2-dimethylpropylthio, and 1,1-dimethylpropylthio groups; and arylthio groups having 6 to 20 carbon atoms such as phenylthio, 4-methylphenylthio, 2-methoxyphenylthio, and 4-t-butylphenylthio groups.

Examples of ring formation by A²¹ and A²², A²³ and A²⁴, A²⁵ and A²⁶, or A²⁷ and A²⁸ through a linking group include —CH₂CH₂CH₂CH₂—, —CH₂CH₂CH(NO₂)CH₂—, —CH₂CH(CH₃)CH₂CH₂—, and —CH₂CH(Cl)CH₂CH₂—. Examples of divalent metals represented by M include Cu, Zn, Fe, CO, Ni, Ru, Rh, Pd, Pt, Mn, Sn, Mg, Hg, Cd, Ba, Ti, Be, and Ca. Examples of monosubstituted trivalent metals include Al—F, Al—Cl, Al—Br, Al—l, Ga—F, Ga—Cl, Ga—Br, Ga—I, In—F, In—I, In—Br, In—I, In—Cl, Tl—F, Tl—Cl, Tl—Br, Tl—l, Al—C₆H₅, Al—C₆H₄, (CH₃), In—C₆H, In-C₆H₄(CH₃), Mn(OH), Mn(OC₆H₅), Mn[OSi(CH₃)₃], Fe—Cl, and Ru—Cl. Examples of disubstituted tetravalent metals include CrCl₂, SiF₂, SiCl₂, SiBr₂, Sil₂, SnF₂, SnCl₂, SnBr₂, ZrCl₂, GeF₂, GeCl₂, GeBr₂, GeI₂, TiF₂, TiCl₂, TiBr₂, Si(OH)₂, Sn(OH)₂, Ge(OH)₂, Zr(OH)₂, Mn(OH)₂, TiR₂, CrR₂, SiR₂, SnR₂, and GeR₂ wherein R represents an alkyl group, a phenyl group, a naphthyl group, or its derivative, Si(OR′)₂, Sn(OR′)₂, Ge(OR′)₂, Ti(OR′)₂, and Cr(OR′)₂ wherein R′ represents an alkyl group, a phenyl group, a naphthyl group, a trialkylsilyl group, a dialkylalkoxysilyl group or its derivative, and Si(SR″)₂, Sn(SR″)₂, and Ge(SR″)₂ wherein R″ represents an alkyl group, a phenyl group, a naphthyl group or its derivative. Examples of oxymetals include VO, MnO, and TiO. Preferred oxymetals include Pd, Cu, Ru, Pt, Ni, CO, Rh, Zn, VO, TiO, Si(Y)₂, and Ge(Y)₂ wherein Y represents a haloen atom or an alkoxy, aryloxy, acyloxy, hydroxy, alkyl, aryl, alkylthio, arylthio, trialkylsilyloxy, trialkyltinoxy, or trialkylgermaniumoxy group. Further preferred are Cu, VO, Ni, Pd, Pt, and CO.

Any compound may be used as (vi) cyanine coloring matters, and examples of suitable cyanine coloirng matters include coloring matters described, for example, in Japanese Patent Laid-Open Nos. 53875/2005, 212454/2002, 54150/2005, 315789/2004 and 228829/2002. Specific examples of cyanine coloring matters which are particularly preferred in the present invention include compounds represented by fromula (7): 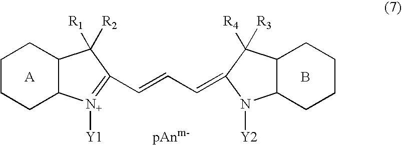
wherein ring A and ring B represent an optionally substituted benzene ring or naphthalene ring; R1 to R4 represent an alkyl group having 1 to 4 carbon atoms, an optionally substituted benzyl group, or R1 and R2, or R3 and R4 may be connected to each other to form a three- to six-membered ring, and at least one of R1 to R4 represents a substituted benzyl group; Y1 and Y2 each independently represent an organic group having 1 to 30 carbon atoms; Aₙ^{m-} represents an m valent anion; m is an integer of 1 or 2; and p represents a coefficient necessary for maintaining the charge in a neutral state.

Any compound may be used as (vii) methine coloring matters, and examples of suitable methine coloring matters include those described, for example, in Japanese Patent Laid-Open Nos. 36033/2003, 200711/2002, and 338822/2002. Specific examples of methine coloring matters which are particularly preferred in the present invention include compounds represented by formula (8): 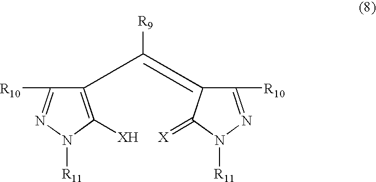
wherein R₉ represents an optionally substituted alkyl group, an optionally substituted aryl group, or a hydrogen atom; R₁₀ represents an optionally substituted alkyl group, an optionally substituted alkoxy group, an optionally substituted alkoxycarbonyl group, an optionally substituted aryl group, an aryloxy group, an optionally substituted aryloxycarbonyl group, an optionally substituted amino group, or a hydrogen atom; R₁₁ represents an optionally substituted alkyl group, an optionally substituted aryl group, or a hydrogen atom; and X represents an oxygen atom or group NH, provided that these R₁₀, R₁₁ and X may be different from each other between both pyrazole rings.

Any compound may be used as (viii) porphyrin coloring matters. Examples of suitable porphyrin coloring matters include those described, for example, in Japanese Patent Laid-Open Nos. 330632/1998, 57437/2003, 45887/2004, and 330175/2003. Specific examples of porphyrin coloring matters which are particularly preferred in the present invention include compounds represented by formula (9): 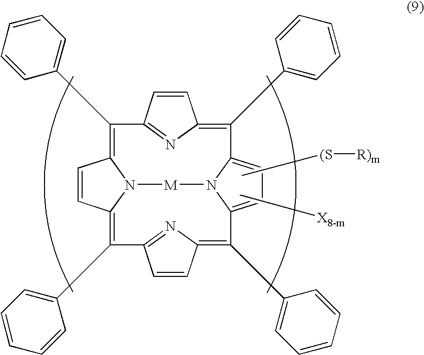
wherein R represents an alkyl group, an optionally substituted phenyl group, or a naphthyl group; X represents a hydrogen atom or a halogen atom; m is an integer of 1 to 8; and M represents two hydrogen atoms, a divalent metal, or a trivalent or tetravalent metal derivative.

Third coloring matter

The coloring matter layer in the optical filter according to the present invention may optionally contain, in addition to the first and second coloring matters, other coloring matter (third coloring matter) other than the first and second coloring matters. The third coloring matter may be any coloring matter so far as the requirement that two or more ionic coloring matter compounds different from each other in cation part are not substantially contained in an identical coloring layer is satisfied. Specific examples of such third coloring matters include coloring matters having an absorption maximum wavelength in a wavelength region of 380 to 570 nm and coloring matters having an absorption maximum wavelength in a wavelength region of 610 to 780 nm.

The use of such third coloring matters can provide a more preferred optical filter which can improve, for example, color purity and color reproduction range of light emitted from panels and color of displays in an off state of a power supply.

Examples of such suitable third coloring matters include those described, for example, in Japanese Patent Laid-Open Nos. 275432/2000, 188121/2001, 350013/2001, and 131530/2002. Other preferred coloring matters include coloring matters capable of absorbing visible light such as yellow light, red light, and blue right, such as (ix) anthraquinone coloring matters, (x) naphthalene coloring matters, (xi) azo coloring matters, (xii) phthalocyanine coloring matters, (xiii) pyrromethene coloring matters, (xiv) tetraazaporphyrin coloring matters, (xv) squarylium coloring matters, and (xvi) cyanine coloring matters.

Among the above coloring matters, (ix) anthraquinone coloring matters, (x) naphthalene coloring matters, (xiii) pyrromethene coloring matters, and (xvi) cyanine coloring matters are particularly preferred.

Transparent resin

The coloring matter layer in the optical filter according to the present invention comprises the above first coloring matter and second coloring matter and optionally third coloring matter contained in a transparent resin.

The transparent resin is not limited so far as the resin has high light transmittance in a visible light region. Specific examples of transparent resins include acrylic resins, polyester resins, polycarbonate resins, urethane resins, cyclic polyolefine resins, polystyrene resins, polyimide resins, or polytetrafluoroethylene (PTFE), perfluoroalkoxy resins (PFAs) comprising tetrafluoroethylene-perfluoroalkyl vinyl ether copolymers, tetrafluoroethylene-hexafluoropropylene copolymers (FEPs), tetrafluoroethylene-perfluoroalkyl vinyl ether-hexafluoropyropylene copolymers (EPEs), tetrafluoroethylene-ethylene or propylene copolymers (ETFEs), polychlorotrifluoroethylene resins (PCTFEs), ethylene-chlorotrifluoroethylene copolymers (ECTFEs), fluorinated vinylidene resins (PVDFs), vinyl fluoride resins (PVFs) and other fluororesins. Among them, acrylic resins and polyester resins are preferred. The average molecular weight of the transparent resin is preferably 500 to 600000, more preferably 10000 to 400000. When the average molecular weight is in the above-defined range, the above properties can be provided.

In the present invention, the coloring matter in the coloring matter layer is sometimes deteriorated by moisture in the air. Further, when the transparent resin contains a hydroxyl group or an acid group or contains a polymerization initiator or the like, a coloring matter deterioration sometimes occurs, for example, due to the action of the hydroxyl group or acid group or the polymerization initiator. To eliminate this problem, the transparent resin preferably has a small hydroxyl or a small acid value, and, more preferably, both the hydroxyl value and the acid value are small.

For the above reason, regarding the transparent resin, the hydroxyl value is preferably not more than 10, more preferably not more than 5, particularly preferably 0 (zero). The low hydroxyl value can prevent, for example, the coloring matters contained in the coloring matter layer from reacting with the hydroxyl group contained in the transparent resin. Therefore, an optical filter, which has spectral characteristics which are stable over time even under high temperature and high humidity conditions, can be provided. The term “hydroxyl value” as used herein refers to mg of potassium hydroxide required for neutralization of acetic acid bonded to a hydroxyl group in the acetylation of 1 g of a sample.

Likewise, for the transparent resin, the acid value is preferably not more than 10, more preferably not more than 5, particularly preferably 0. When the acid value is small, for example, a reaction of the acid contained in the transparent resin with the coloring matter can be prevented. Therefore, an optical filter, which has spectral characteristics which are stable over time even under high temperature and high humidity conditions, can be provided. The term “acid value” as used herein refers to mg of potassium hydroxide required for neutralization of 1 g of a sample.

Preferably, for the transparent resin, the glass transition temperature (hereinafter often referred to as “Tg”) is the temperature or above the temperature at which the optical filter is actually used. The reason for this is as follows. When the glass transition temperature is below the temperature at which the optical filter is actually used, in other words, when the optical filter is used at or above the glass transition temperature, a coloring matter deterioration or a transparent resin deterioration is likely to occur as a result of a reaction between coloring matters contained in the transparent resin, or absorption of moisture in the air by the transparent resin.

For the above reason, the glass transition temperature of the transparent resin is preferably, for example, 80 to 150° C. although it also varies depending upon the temperature of the optical filter actually used. The use of a transparent resin having a glass transition temperature below 80° C. causes, for example, interaction between the coloring matters and the transparent resin, or interaction between coloring matters, resulting in denaturation of the coloring matters. On the other hand, the use of a transparent resin having a glass transition temperature above 150° C. leads to a fear of causing a heat deterioration of the coloring matters, because, in the dissolution of the transparent resin in a solvent to prepare a composition for coloring matter layer formation followed by the formation of the coloring matter layer by coating, the drying temperature should be high for satisfactory drying. When the drying temperature is lowered to avoid this unfavorable phenomenon, a long drying time is necessary. This lowers the efficiency of the step of drying, leading to an increase in production cost, or causes unsatisfactory drying which is causative of a deterioration in coloring matters by the residual solvent.

The mixing ratio between the coloring matter and the transparent resin in the coloring matter layer is preferably 0.001 to 100, more preferably 0.01 to 50, particularly preferably 0.1 to 20, based on 100 of the transparent resin for the first coloring matter; preferably 0.001 to 50, more preferably 0.01 to 20, particularly preferably 0.1 to 10, based on 100 of the transparent resin for the second coloring matter; and preferably 0 to 10, more preferably 0.01 to 5, based on 100 of the transparent resin for the third coloring matter. The mixing ratio is by mass.

<Optical filter (part 2)>

In a preferred embodiment of the optical filter according to the present invention, one or at least two layers having one or at least two functions of electromagnetic wave shielding functions, antireflection functions, anti-dazzling functions, antifouling functions, and ultraviolet absorption functions are further provided.

An electromagnetic wave shielding function layer, a color tone regulating function layer, an antireflection function layer, an anti-dazzling function layer, an antifouling function layer, and an ultraviolet absorption function layer which are preferred in the present invention will be described in detail.

Electromagnetic wave shielding function layer

The electromagnetic wave shielding function layer which may be added to the coloring matter layer according to the present invention functions to shield electromagnetic waves generated from electrical or electronic devices, especially plasma displays. A metal mesh layer and a transparent electrically conductive thin film layer may be utilized as the electromagnetic wave shielding function layer. Metal mesh is preferred from the viewpoint of high electromagnetic wave shielding properties. The metal mesh layer is formed by stacking a metal foil on a transparent base material and conducting etching to form mesh. Accordingly, it is common practice to interpose an adhesive layer between the transparent base material and the metal mesh. Adhesives usable for constituting the adhesive layer include acrylic resins, polyester resins, polyurethane resins, polyvinyl alcohol per se or partially saponified products thereof, vinyl chloride-vinyl acetate copolymers, ethylene-vinyl acetate copolymers, polyimide resins, epoxy resins, and polyurethane ester resins. The type of the metal constituting the metal mesh layer is not particularly limited so far as the metal has electromagnetic wave shielding properties, and examples thereof include copper, iron, nickel, chromium, aluminum, gold, silver, stainless steel, tungsten, chromium, and titanium. Among others, copper is preferred. Copper foils including rolled copper foils and electrolytic copper foils are usable. Particularly preferred are electrolytic copper foils. This is because the electrolytic copper foil can realize an even foil having a thickness of not more than 10 μm and, in addition, upon blackening treatment, adhesion to chromium oxide or the like can be improved.

In the present invention, preferably, one side or both sides of the metal mesh have been subjected to blackening treatment. The blackening treatment is treatment for blackening the surface of the metal mesh, for example, by chromium oxide. In applying the metal mesh to the coloring matter layer, the oxidized surface is disposed so as to constitute a viewer side face. The chromium oxide or the like formed on the surface of the metal mesh layer by the blackening treatment can absorb external light on the surface of the metal mesh layer, and, thus, scattering of light on the surface of the metal mesh layer can be prevented.

The open area ratio of the metal mesh layer is preferably as low as possible from the viewpoint of electromagnetic wave shielding properties. When the open area ratio is excessively low, the light transmittance is lowered. Therefore, the open area ratio is preferably not less than 50%.

Further, in the metal mesh layer, the opening parts and the nonopening parts constitute concaves and convexes. Accordingly, a flattening layer formed of a transparent resin having a larger thickness than the metal mesh layer may be formed on the metal mesh layer.

Antireflection function layer

The antireflection function layer which may be added to the coloring matter layer according to the present invention typically comprises a higher refractive index layer and a lower refractive index layer stacked in that order. The antireflection function layer, however, may have other laminate structure. The higher refractive index layer is formed of, for example, a thin film of a material such as ZnO or TiO₂, or a transparent resin film containing fine particles of the above material. On the other hand, the lower refractive index layer may be formed of a thin film of SiO₂, or an SiO₂ gel film, or a transparent resin film containing fluorine or a transparent resin film containing fluorine and silicon. Stacking of the antireflection layer can lower the reflection of unnecessary light such as external light on the stacked side and can enhance contrast of images or pictures of displays to which the optical filter is applied.

Anti-dazzling function layer

The anti-dazzling function layer which may be added to the coloring matter layer according to the present invention may comprise, for example, beads having a diameter of approximately several micrometers formed of polystyrene resins, acrylic resins or the like contained in a transparent resin. The anti-dazzling function layer functions to prevent scintillation caused due to light spreading properties of the layer in a particular position or direction of displays when the optical filter is disposed on the front face of the display.

Antifouling function layer

The antifouling function layer which may be added to the coloring matter layer according to the present invention is a layer which, in using the near infrared absorbing film or its laminate, functions to prevent the deposition of dust or contaminants on the surface caused by inadvertent contact or contamination from the environment, or to facilitate removal of dust or contaminants even when deposited. The antifouling function layer may be formed of, for example, fluorocoating agent, a silicone coating agent, or a silione-fluorocoating agent. Among others, the silicone-fluorocoating agent is preferably applied. The thickness of the antifouling layer is preferably not more than 100 nm, more preferably not more than 10 nm, further preferably not more than 5 nm. When the thickness of the antifouling layer exceeds 100 nm; the durability is poor although the initial value of the antifouling properties is excellent. The thickness of the antifouling layer is most preferably not more than 5 nm from the viewpoint of balance between the antifouling properties and the durability.

Ultraviolet absorbing function layer

The ultraviolet absorbing function layer which may be added to the coloring matter layer according to the present invention functions to shield or control ultraviolet light emitted from electric or electronic devices or ultraviolet light contained in natural light or the like, whereby the durability of various resin materials or other constituent materials constituting displays (for example, transparent resin materials and coloring matters) can be further improved.

In the present invention, an ultraviolet absorbing layer, in which, for example, the light transmittance over the whole wavelength region below 380 nm is not more than 40%, preferably not more than 30% may be provided on any place in the filter construction for displays. The optical filter provided with the ultraviolet absorbing layer is one preferred embodiment of the present invention.

The ultraviolet absorber may be contained in the transparent base material, or alternatively may be provided as an independent layer containing an ultraviolet absorber, that is, as an ultraviolet absorbing layer. The ultraviolet light absorbing layer is generally formed as a layer having a thickness of 0.1 to 30 μm, preferably 0.5 to 10 μm, by coating a material comprising an ultraviolet absorber contained in a binder resin, for example, an acrylic resin, a polycarbonate resin, an ethylene-vinyl alcohol copolymer resin, an ethylene-vinyl acetate copolymer resin, an acrylonitrile-styrene copolymer resin (AS resin), a polyester resin, a vinyl chloride-vinyl acetate resin, a polyvinyl butyral resin, PVPA, a polystyrene resin, a phenolic resin, a phenoxy resin, polysulfone, nylon, a cellulosic resin, or a cellulose acetate resin. The ultraviolet absorbing layer is preferably provided so that, in use as a filter, the ultraviolet absorbing layer is located on the more external side as compared with the coloring matter layer, or alternatively is incorporated in a layer located on the more external side as compared with the coloring matter layer, from the viewpoint of protecting the coloring matters in the coloring matter layer.

Ultraviolet absorbers include organic ultraviolet absorbers, for example, benzotriazole ultraviolet absorbers such as 2-(2′-hydroxy-5′-methylphenyl)benzotriazole, 2-(2′-hydroxy-5′-butylphenyl)benzotriazole, 2-(2′-hydroxy-5′-t-butylphenyl)benzotriazole, 2-(2′-hydroxy-5′-t-octylphenyl)benzotriazole, 2-(2′-hydroxy-3′,5′-di-t-butylphenyl)benzotriazole, 2-(2′-hydroxy-3′,5′-di-t-amylphenyl)benzotriazole, 2-(2′-hydroxy-3′-t-butyl-5′-methylphenyl)-5-chlorobenzotriazole, and 2-(2′-hydroxy-3′,5′-di-t-butylphenyl)-5-chlorobenzotriazole; benzophenone ultraviolet absorbers such as 2,4-dihydroxybenzophenone, 2-hydroxy-4-methoxybenzophenone, 2-hydroxy-4-octyloxybenzophenone, 2-hydroxy-4-dodecyloxybenzophenone, 2,2′-dihydroxy-4-methoxybenzophenone, and 2,2′-dihydroxy-4,4′-dimethoxybenzophenone; salicylate ultraviolet absorbers such as phenyl salicylate, p-t-butylphenyl salicylate, and p-octylphenyl salcylate; and benzoate ultraviolet absorbers such as hexadecyl-2,5-t-butyl-4-hydroxybenzoate, and 2,4-di-t-butylphenyl-3′,5′-di-t-butyl-4′-hydroxybenzoate, and inorganic ultraviolet absorbers such as titanium oxide, zinc oxide, cerium oxide, iron oxide, and barium sulfate.

Regarding the absorption capability of the ultraviolet absorbing layer, the transmittance of ultraviolet light with a wavelength of not more than 380 nm is preferably not more than 30%, and 100% cutoff of ultraviolet light with a wavelength of not more than 380 nm is of course better. This can realize suppression of a deterioration in coloring matter by ultraviolet light and can realize an optical filter which can stably exhibit an optical absorption function and an initial color tone for a long period of time.

As described above, the independent ultraviolet absorbing layer may also be formed by stacking of a commercially available ultraviolet cutoff filter, for example, “Sharp cut filter SC-38”, “Sharp cut filter SC-39”, and “Sharp cut filter SC-40” (tradenames), manufactured by Fuji Photo Film Co., Ltd., and “ACRYPLEN” (tradename), manufactured by Mitsubishi Rayon Co., Ltd., instead of the provision of the ultraviolet absorber-containing layer.

Form of optical filter

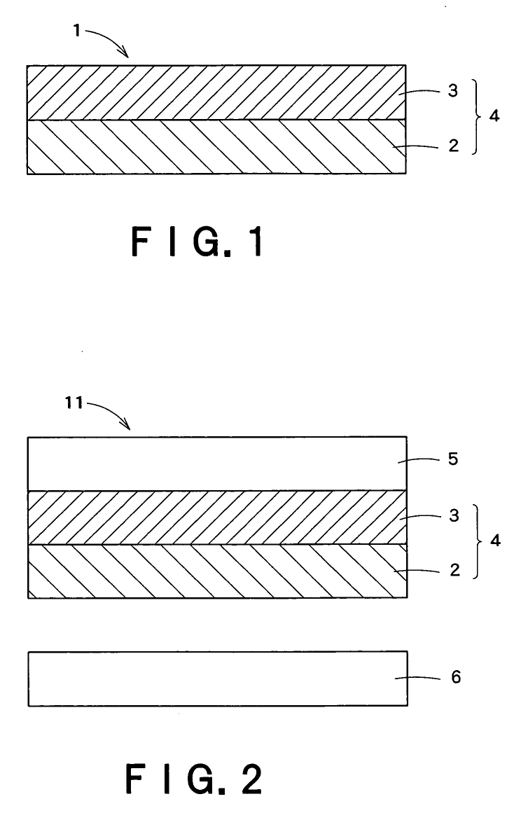

FIGS. 1 and 2 are cross-sectional views showing examples of the laminate structure of the optical filter according to the present invention.

As indicated by numeral 1 in FIG. 1, the optical fitler according to the present invention is most basically a laminate 4 comprising a transparent base material 2 and a coloring material layer 3. This transparent base material 2 may be one subjected to treatment for improving the adhesion which may be carried out in the lamination.

Instead of the transparent base material 2 in the optical filter according to the present invention, a function layer known in the field of the optical filter may be used. The function layer may be one layer or two or more layers having any one or at least two of, for example, electromagnetic wave shielding functions, color tone regulating functions, antireflection functions, anti-dazzling functions, antifouling functions, and ultraviolet absorption functions.

The transparent base material 2 is not particularly limited so far as the coloring matter layer 3 can be stacked, and examples thereof include films of polyesters such as polyethylene terephthalate (PET) and polyethylene naphthalate (PEN), polyolefins such as cyclic polyolefins, polyethylens, polypropylens, and polystyrenes, vinyl resins such as polyvinyl chloride and polyvinylidene chloride, and resins such as polycarbonates, acrylic resins, triacetylcellulose (TAC), polyethersulfone, or polyether ketone. They may be used alone or in the form of a laminate of two or more of an identical type or different types.

Regarding the transparency of the transparent base material 2, when the transparent base material is in the form of a single layer, the transmittance of light in a visible region is preferably not less than 80%. “Transparent” is preferably in a colorless and transparent state. However, the colorless and transparent state is not necessarily required, and, so far as the object of the present invention is not sacrificed, a colored transparent state is also possible. The light transmittance in a visible region is preferably as high as possible. In this case, however, it should be noted that, since a light transmittance of not less than 50% is necessary as a final production, even in the case of stacking of at least 2 base materials, a light transmittance of 80% for each transparent base material suffices for contemplated purposes. It is a matter of course that the number of transparent base materials which may be stacked increases with increasing the light transmittance. Therefore, the light transmittance of a single layer form of the transparent base material 2 is more preferably not less than 85%, most preferably not less than 90%. Reducing the thickness is also effective means for improving the light transmittance.

The thickness of the transparent base material 2 is not particularly limited so far as the transparency is satisfied. However, a thickness in the range of about 12 μm to about 300 μm is preferred from the viewpoint of processability. When the thickness is less than 12 μm, the transparent base material 2 is so soft that stretching or wrinkle is likely to occur due to the tension applied in the processing. On the other hand, when the thickness exceeds 300 μm, the flexibility of the film is reduced, making it difficult to conduct continuous winding in each step. Further, in this case, a significant deterioration in processability in the stacking of a plurality of transparent base materials on top of each other disadvantageously occurs.

Methods for coloring matter 3 formation include, for example, (i) a method in which a composition for coloring matter layer formation is coated onto a transparent base material 2 and the composition for coloring material layer formation after coating is dried or cured by heat, ultraviolet light, electron beam or the like to form the coloring matter layer 3 and (ii) a method in which the composition for coloring matter layer formation is formed into a film which is then applied to the transparent base material 2 to provide a laminate. The method (i) is preferred from the viewpoint of its simplicity.

In the formation of the coloring matter layer 3, methods usable for coating of the composition for coloring matter layer formation onto the transparent base material include various coating methods, for example, dipping, spraying, brushing, Mayer bar coating, doctor blade coating, gravure coating, gravure reverse coating, kiss reverse coating, triple roll reverse coating, slit reverse die coating, die coating, and Komma coating.

The thickness of the coloring matter layer 3 may be properly set depending upon applications and the like, and is not particularly limited. For example, the thickness of the coloring matter layer 3 is preferably 0.5 to 1,000 μm, more preferably 1 to 100 μm, still more preferably 1 to 50 μm, particularly preferably 1 to 30 μm, on a dry basis.

A function layer 5 known in the field of the optical filter may if necessary be provided on the optical filter 1 according to the present invention to constitute an optical filter 11 as shown in FIG. 2. The function layer 5 may comprise one layer or two or more layers having any one or at least two of electromagnetic wave shielding functions, antireflection functions, anti-dazzling functions, antifouling functions, and ultraviolet absorption functions.

Methods for this function layer 5 formation include, for example, (i) a method in which material for function layer formation is coated onto a laminate 4 and the material for function layer formation after coating is dried or cured by heat, ultraviolet light, electron beam or the like and (ii) a method in which a film of the function layer 5 is applied onto the laminate 4. The method (i) is preferred from the viewpoint of its simplicity.

<Display>

The display according to the present invention is characterized by comprising the optical filter disposed on a display in its viewer side.

When the optical filter according to the present invention is used for PDP applications, as shown in FIG. 2, the optical filter is installed on the front face of the display to cutoff unfavorable light or electromagnetic waves or the like such as near infrared light, neon light or the like emitted from a plasma display panel 6.

In the display filter according to the present invention, when the transmittance of visible light is low, the sharpness of the image is lowered. Accordingly, the higher the transmittance of visible light, the better the results. The necessary light transmittance is at least 30%, preferably at least 35%. The near infrared light cutoff region is preferably designed so that, since the wavelength of light emitted from PDP is in the range of 800 to 1100 nm, the transmittance of light in this region is not more than 30%. On the other hand, the cutoff region of neon light is 570 to 610 nm, and, in this case, the near infrared light cutoff region is preferably designed so that the light transmittance in the wavelength 590 nm is not more than 50%.

### EXAMPLES

The following Examples and Comparative Examples further illustrate the present invention. However, it should be noted that the present invention is not limited thereby. In the following description, Ph represents phenyl, and Pc phthalocyanine.

### Synthesis Example 1

### Synthesis of Phthalocyanine Coloring Matter (A)

3-Phenoxy-4,5-bis(2,5-dichlorophenoxy)-6-fluorophthalonitrile (20 g, 34 mmol), 2 g of vanadium trichloride (13 mmol), and 30 ml of n-octanol were charged into a 250 ml four-necked flask, and the contents of the flask were held while bubbling nitrogen with stirring at 170° C. for about 4 hr. Thereafter, the contents of the flask were cooled to room temperature. Thereafter, 15 g (136 mmol) of PhCH₂NH₂ and 120 ml of benzonitrile were added thereto, and the mixture was held while maintaining the temperature at 90° C. for about 5 hr. The reaction solution was cooled, followed by precipitation by a phthalonitrile method. The precipitates thus obtained were then dried in vacuum to give 180 g of VOPc (2,5-Cl₂PhO)₈(PhO)₄(PhCH₂NH)₄. The phthalocyanine coloring matter (A) was dispersed in a polyester resin (Vylon200, manufactured by Toyobo Co., Ltd.). The maximum absorption wavelength of the dispersion was 878 nm.

### Synthesis Example 2

### Synthesis of Phthalocyanine Coloring Matter (B)

CuPc (2,5-Cl₂PhO)₈(PhO)₄(PhCH₂NH)₄ (180 g) was prepared in the same manner as in the synthesis of compound (A), except that 1 g (10 mmol) of copper chloride was used instead of vanadium trichloride. The phthalocyanine coloring matter (D) was dispersed in a polyester resin (Vylon200, manufactured by Toyobo Co., Ltd.). The maximum absorption wavelength of the dispersion was 810 nm.

### <Example 1>

An acrylic resin solution was prepared by dissolving an acrylic resin (tradename: BR-80, manufactured by Mitsubishi Rayon Co., Ltd.) in methyl ethyl ketone/toluene (solvent mixing ratio=1:1) so that the solid content was 20% (on a mass basis). Coloring matters having an absorption maximum between wavelengths 800 nm and 1100 nm, i.e., 0.11 g of the phthalocyanine coloring matter (A) synthesized in Synthesis Example 1, 0.12 g of the phthalocyanine coloring matter (B) synthesized in Synthesis Example 2, and 0.25 g of a commercially available diimmonium coloring matter (stock number: IRG-068, Nippon Kayaku Co., Ltd., R¹=iso-butyl group for all of eight R¹s, and R²=trifluoromethyl group), and a coloring matter having an absorption maximum between wavelengths 570 nm and 610 nm, i.e., 0.04 g of a commercially available tetraazaporphyrin (stock number: TAP12, Yamada Kagaku K.K.), were added to 19.6 g of the acrylic resin solution, and the mixture was thoroughly dispersed to prepare a coating solution which was then coated onto a commercially available PET film (tradename: “Cosmoshine A4300”, manufactured by Toyobo Co., Ltd.) by Mayer bar coating to a coating thickness of 5 μm on a dry basis. The coating was dried in an oven in which dry air was sprayed at a wind velocity of 5 m/sec under conditions of 100° C. and 1 min to prepare an optical filter which can develop an optical absorption function of wavelengths 800 nm to 1100 nm and an optical absorption function of wavelengths 570 nm to 610 nm in an identical layer.

For the optical filter thus obtained, the average value of light transmittance at wavelengths 800 nm to 1100 nm was 5.2%, and the light transmittance at 590 nm was 32.5%. The optical filter was allowed to stand in an atmosphere of temperature 60° C. and humidity 90% RH for 1000 hr. As a result, the average value of light transmittance at wavelengths 800 nm to 1100 nm and the light transmittance at 590 nm remained substantially unchanged and were 5.3% and 32.0%, respectively.

### <Example 2>

An optical filter having the function of absorbing light with wavelengths 800 nm to 1100 nm and the function of absorbing light with wavelengths 570 nm to 610 nm and, further, an antireflection function was prepared in the same manner as in Example 1, except that a commercially available antireflection film comprising a triacetylcellulose film as a base material (tradename; “Realook 8200 UV,” manufactured by Nippon Oils & Fats Co., Ltd.) was used as a support base material instead of a commercially available PET film (Cosmoshine A4300, manufactured by Toyobo Co., Ltd.), for the formation of a near infrared absorbing layer on the triacetylcellulose film as the antireflection film.

For the optical filter thus obtained, the average value of light transmittance at wavelengths 800 nm to 1100 nm was 5.7%, and the light transmittance at 590 nm was 31.8%. The optical filter was allowed to stand in an atmosphere of temperature 60° C. and humidity 90% RH for 1000 hr. As a result, the average value of light transmittance at wavelengths 800 nm to 1100 nm and the light transmittance at 590 nm remained substantially unchanged and were 5.9% and 32.2%, respectively.

### <Example 3>

An optical filter, which can develop the function of absorbing light with wavelengths 800 nm to 1100 nm and the function of absorbing light with wavelengths 570 nm to 610 nm and, further, a color adjustment function in an identical layer, was prepared in the same manner as in Example 1, except that 0.02 g of a coloring matter for color adjustment having an absorption maximum wavelength of 508 nm (Plast red 8320, Arimoto Chemical Company Ltd.) was added to the coating solution containing a coloring matter capable of absorbing wavelengths 800 nm to 1100 nm and a coloring matter capable of absorbing wavelengths 570 nm to 610 nm described in Example 1.

For the optical filter thus obtained, the average value of light transmittance at wavelengths 800 nm to 1100 nm was 5.5%, and the light transmittance at 590 nm was 30.8%. The optical filter was allowed to stand in an atmosphere of temperature 60° C. and humidity 90% RH for 1000 hr. As a result, the average value of light transmittance at wavelengths 800 nm to 1100 nm and the light transmittance at 590 nm remained substantially unchanged and were 5.9% and 31.1%, respectively.

### <Example 4>

An optical filter, which can develop the function of absorbing light with wavelengths 800 nm to 1100 nm and the function of absorbing light with wavelengths 570 nm to 610 nm in an identical layer, was prepared in the same manner as in Example 1, except that CIR-1085 (R¹=n-butyl group for all of eight R¹s, and R²=trifluoromethyl group; a product of Japan Carlit) was used as a commercially available diimmonium coloring matter instead of IRG-068.

For the optical filter thus obtained, the average value of light transmittance at wavelengths 800 nm to 1100 nm was 4.5%, and the light transmittance at 590 nm was 31.4%. The optical filter was allowed to stand in an atmosphere of temperature 60° C. and humidity 90% RH for 1000 hr. As a result, the average value of light transmittance at wavelengths 800 nm to 1100 nm and the light transmittance at 590 nm remained substantially unchanged and were 5.3% and 31.9%, respectively.

### <Comparative Example 1>

An optical filter, which can develop the function of absorbing light with wavelengths 800 nm to 1100 nm and the function of absorbing light with wavelengths 570 nm to 610 nm in an identical layer, was prepared in the same manner as in Example 1, except that 0.25 g of a commercially available diimmonium coloring matter (part number: CIR-1085; a product of Japan Carlit Co., Ltd.) as a coloring matter capable of absorbing wavelengths 800 to 1100 nm and 0.10 g of a commercially available cyanine coloring matter (part number: TY167, Asahi Denka Kogyo Ltd.) as a coloring matter capable of absorbing wavelengths 570 to 610 nm were used.

For the optical filter thus obtained, the average value of light transmittance at wavelengths 800 nm to 1100 nm was 6.5%, and the light transmittance at 590 nm was 34.2%. The optical filter was allowed to stand in an atmosphere of temperature 60° C. and humidity 90% RH for 1000 hr. As a result, the average value of light transmittance at wavelengths 800 nm to 1100 nm and the light transmittance at 590 nm were 25.3% and 57.9%, respectively. Thus, the combined use of the diimmonium coloring matter and the cyanine coloring matter, i.e., ionic coloring matter compounds comprising cation and anion, caused a significant change in spectral characteristics.

### <Comparative Example 2>

An optical filter, which can develop the function of absorbing light with wavelengths 800 nm to 1100 nm and the function of absorbing light with wavelengths 570 nm to 610 nm in an identical layer, was prepared in the same manner as in Example 1, except that 0.11 g of the phthalocyanine coloring matter (A) synthesized in Synthesis Example 1, 0.12 g of the phthalocyanine coloring matter (B) synthesized in Synthesis Example A2, and 0.25 g of a commercially available diimmonium coloring matter (part number: CIR-1085; a product of Japan Carlit Co., Ltd.) were used as the coloring matter capable of absorbing wavelengths 800 to 1100 nm, and 0.10 g of a commercially available cyanine coloring matter (part number: TY167; a product of Asahi Denka Kogyo Ltd.) was used as the coloring matter capable of absorbing wavelengths 570 to 610 nm.

For the optical filter thus obtained, the average value of light transmittance at wavelengths 800 nm to 1100 nm was 6.1%, and the light transmittance at 590 nm was 32.2%. The optical filter was allowed to stand in an atmosphere of temperature 60° C. and humidity 90% RH for 1000 hr. As a result, the average value of light transmittance at wavelengths 800 nm to 1100 nm and the light transmittance at 590 nm were 26.3% and 53.9%, respectively. Thus, in this Comparative Example, although a phthalocyanine coloring matter was used, as with Comparative Example 1, a significant change in spectral characteristics took place due to the combined use of the diimmonium coloring matter and the cyanine coloring matter, i.e., ionic coloring matter compounds comprising cation and anion.

Thus, by virtue of the construction of the optical filter according to the first invention which comprises at least a coloring matter layer comprising a coloring matter having an absorption maximum wavelength in a wavelength region of 800 to 1100 nm and a coloring matter having an absorption maximum in a wavelength region of 570 to 610 nm contained in an identical layer, wherein the coloring matter layer does not substantially contain two or more ionic coloring matter compounds different from each other in cation part, even when a plurality of coloring matters are present as a mixture in an identical layer, in the optical filter, interaction between coloring matters is suppressed, an ion exchange reaction between coloring matters is less likely to take place and any change in spectral characteristics does not occur under use for a long period of time.

Further, according to the second invention, by virtue of the construction of the optical filter in which the coloring matter having an absorption maximum wavelength in a wavelength region of 800 to 1100 nm is at least a specific phthalocyanine coloring matter represented by formula (1), the optical filter has further improved durability.

According to the third invention, by virtue of the construction of the optical filter in which the coloring matter having an absorption maximum in a wavelength region of 570 to 610 nm is a specific tetraazaporphyrin coloring matter represented by formula (2), the optical filter has further improved durability.

According to the fourth invention, by virtue of the construction of the optical filter in which said ionic coloring matter compound is a diimmonium coloring matter or a squarylium coloring matter, in the optical filter, in addition to the effects attained by the first to third inventions, further improved durability can be realized.

According to the fifth invention, by virtue of the use of the specific diimmonium coloring matter represented by general formula (3), in addition to the effects attained by the first to fourth inventions, the optical filter can retain the excellent near infrared absorption capability in the early stage over a long period of time.

According to the sixth and seventh inventions, by virtue of the use of a specific alkyl group as the branched-chain alkyl in the cation component, in addition to the effects attained by the first to fifth inventions, the optical filter can realize excellent durability.

According to the eighth invention, by virtue of the use of a substituted or unsubstituted alkyl group and a substituted or unsubstituted aryl group in R² in the anion component, in addition to the effects attained by the first to seventh inventions, the optical filter can further realize further improved durability.

According to the ninth invention, by virtue of the use of an alkyl or aryl group containing a halogen in its substituent in R² in the anion component, in addition to the effects attained by the first to eighth inventions, the optical filter can realize excellent durability.

According to the tenth invention, by virtue of the construction of the optical filter in which the coloring matter layer is formed of a coloring matter having an absorption maximum wavelength in a wavelength region of 800 to 1100 nm and a coloring matter having an absorption maximum in a wavelength region of 570 to 610 nm contained in a transparent resin, in addition to the effects attained by the first to ninth inventions, the optical filter can realize further improved durability.

According to the eleventh invention, by virtue of the construction of the optical filter in which at least one of a coloring matter having an absorption maximum wavelength in a wavelength region of 380 to 570 nm and a coloring matter having an absorption maximum in a wavelength region of 610 to 780 nm is further contained in said coloring matter layer, in addition to the effects attained by the first to tenth inventions, the optical filter can realize improved color purity of light emitted from the panel, color reproduction range and the like.

According to the twelfth invention, by virtue of the construction of the optical filter in which a layer(s) for any one or at least two of electromagnetic wave shielding functions, antireflection functions, anti-dazzling functions, antifouling functions, and ultraviolet absorption functions is provided, in addition to the effects attained by the first to eleventh inventions, further effects can be attained.

According to the thirteenth invention, there is provided a display comprising an optical filter, which can exhibit the effects attained by any one of the first to twelfth inventions, disposed on a display in its viewer side.

1. An optical filter comprising at least a coloring matter layer comprising a coloring matter having an absorption maximum wavelength in a wavelength region of 800 to 1100 nm and a coloring matter having an absorption maximum in a wavelength region of 570 to 610 nm contained in an identical layer, wherein
said coloring matter layer does not substantially contain two or more ionic coloring matter compounds different from each other in cation part.

2. The optical filter according to claim 1, wherein said coloring matter having an absorption maximum wavelength in a wavelength region of 800 to 1100 nm is at least a phthalocyanine coloring matter represented by formula (1): 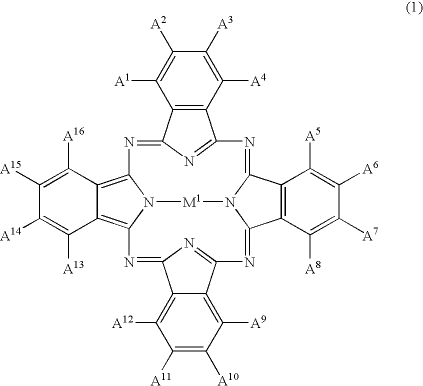
wherein A¹ to A¹⁶ each independently represent a hydrogen atom, a halogen atom, a hydroxyl group, an amino group, a hydroxysulfonyl group, an aminosulfonyl group, or a substituent having 1 to 20 carbon atoms optionally containing a nitrogen, sulfur, oxygen, or halogen atom, and adjacent two substituents may be connected to each other through a linking group, provided that at least four of A¹ to A¹⁶ represent a substituent through a sulfur or nitrogen atom; and M¹ represents copper or vanadium oxide.

3. The optical filter according to claim 1, wherein the coloring matter having an absorption maximum in a wavelength region of 570 to 610 nm is a tetraazaporphyrin coloring matter represented by formula (2): 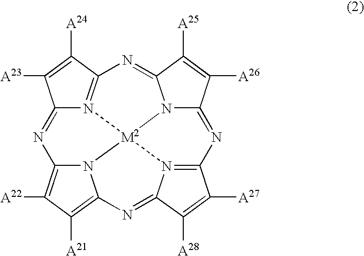
wherein A²¹ to A²⁸ each independently represent a hydrogen atom, a halogen atom, a nitro group, a cyano group, a hydroxy group, an amino group, a carboxyl group, a sulfonic acid group, or an alkyl, halogenoalkyl, alkoxy, alkoxyalkoxy, aryloxy, monoalkylamino, dialkylamino, aralkyl, aryl, heteroaryl, alkylthio, or arylthio group having 1 to 20 carbon atoms; A²¹ and A²², A²³ and A²⁴, A²⁵ and A²⁶, and A²⁷ and A²⁸ each independently may form a ring except for an aromatic ring through a linking group; and M² represents two hydrogen atoms, a divalent metal atom, a trivalent monosubstitued metal atom, a tetravalent disubstituted metal atom, or an oxymetal atom.

4. The optical filter according to claim 1, wherein said ionic coloring matter compound is a diimmonium coloring matter or a squarylium coloring matter.

5. The optical filter according to claim 1, wherein said ionic coloring matter compound is a diimmonium coloring matter represented by general formula (3): 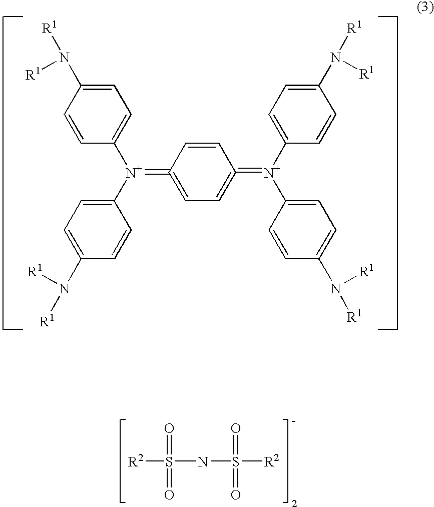
wherein R¹s each independently represent a hydrogen atom, a halogen atom, a nitro group, a cyano group, a thiocyanate group, a cyanate group, an acyl group, a carbamoyl group, an alkylaminocarbonyl group, a substituted or unsubstituted alkoxycarbonyl group, a substituted or unsubstituted aryloxycarbonyl group, a substituted or unsubstituted alkyl group, a substituted or unsubstituted aryl group, a substituted or unsubstituted alkoxy group, a substituted or unsubstituted aryloxy group, a substituted or unsubstituted alkylthio group, a substituted or unsubstituted arylthio group, a substituted or unsubstituted alkylamino group, a substituted or unsubstituted arylamino group, a substituted or unsubstituted alkylcarbonylamino group, or a substituted or unsubstituted arylcarbonylamino group, provided that at least one of R¹s in general formula (3) represents a branched-chain alkyl group; R²s each independently represent a hydrogen atom, a halogen atom, a nitro group, a cyano group, a thiocyanate group, a cyanate group, an acyl group, a carbamoyl group, an alkylaminocarbonyl group, a substituted or unsubstituted alkoxycarbonyl group, a substituted or unsubstituted aryloxycarbonyl group, a substituted or unsubstituted alkyl group, a substituted or unsubstituted aryl group, a substituted or unsubstituted alkoxy group, a substituted or unsubstituted aryloxy group, a substituted or unsubstituted alkylthio group, a substituted or unsubstituted arylthio group, a substituted or unsubstituted alkylamino group, a substituted or unsubstituted arylamino group, a substituted or unsubstituted alkylcarbonylamino group, or a substituted or unsubstituted arylcarbonylamino group; and the anion component is a sulfonylimide-containing monovalent anion.

6. The optical filter according to claim 5, wherein said branched-chain alkyl group in R¹ in general formula (3) has 2 to 8 carbon atoms.

7. The optical filter according to claim 5, wherein said branched-chain alkyl group in R¹ in general formula (3) represents 1-methylethyl, 1,1-dimethylethyl, 1-methylpropyl, 2-methylpropyl, 1-methylbutyl, 2-methylbutyl, 3-methylbutyl, or 2-ethylbutyl group.

8. The optical filter according to claim 5, wherein R² in general formula (3) represents a substituted or unsubstituted alkyl group or a substituted or unsubstituted aryl group.

9. The optical filter according to claim 5, wherein R² in general formula (3) represents an alkyl group containing a halogen as a substituent, or an aryl group.

10. The optical filter according to claim 1, wherein said coloring matter layer is formed of a coloring matter having an absorption maximum wavelength in a wavelength region of 800 to 1100 nm and a coloring matter having an absorption maximum in a wavelength region of 570 to 610 nm contained in a transparent resin.

11. The optical filter according to claim 1, wherein at least one of a coloring matter having an absorption maximum wavelength in a wavelength region of 380 to 570 nm and a coloring matter having an absorption maximum wavelength in a wavelength region of 610 to 780 nm is further contained in said coloring matter layer.

12. The optical filter according to claim 1, which further comprises one layer or two or more layers having any one or at least two of electromagnetic wave shielding functions, antireflection functions, anti-dazzling functions, antifouling functions, and ultraviolet absorption functions.

13. A display comprising an optical filter according to claim 1 disposed on a display in its viewer side.
